(19) United States
(12) Patent Application Publication
(10) Pub. No.: US 2023/0419701 A1
(43) Pub. Date: Dec. 28, 2023

(54) Method, System and Apparatus for Processing Candidate Strings Detected in an Image

(71) Applicant: MATROX ELECTRONICS SYSTEMS, LTD., Lincolnshire, IL (US)

(72) Inventors: François Morin, Montreal (CA); Valentin Pollet, Montreal (CA)

(21) Appl. No.: 18/202,273

(22) Filed: May 25, 2023

Related U.S. Application Data
(60) Provisional application No. 63/356,455, filed on Jun. 28, 2022.

(51) Int. Cl. G06V 30/19; G06F 40/166

(52) U.S. Cl. CPC G06V 30/19093; G06F 40/166

(57) ABSTRACT

A method of identifying a match for a model string in an image includes performing optical character recognition on the image to identify a candidate string including a plurality of candidate characters. A minimum edit cost is determined between the candidate string and the model string, the model string including a plurality of model characters. The minimum edit cost represents a cost of edit operations performed on the candidate string to satisfy characteristics of the model string. If there is a missing or invalid candidate character in the candidate string, the minimum edit cost includes a special cost of an edit operation for identifying the missing or invalid candidate character. If based on the minimum edit cost the candidate string is a match for the model string, a partial string corresponding to the candidate string including a label representing the missing or invalid character is returned as the output string.

### BACKGROUND OF INVENTION

### 1. Field of Invention

Embodiments of the invention relate to the field of image processing, and more specifically, to the processing of candidate strings resulting from optical character recognition performed on an image to identify a match for a model string in the image.

### 2. Discussion of Related Art

Optical Character Recognition (OCR) generally refers to the mechanism of converting images of typed, handwritten or printed text into machine-encoded text (e.g., in an American Standard Code for Information Interchange (ASCII) format), whether from a scanned document, a photo of a document, a photo of a scene (e.g., an image acquired by a surveillance camera including a license plate number) or from subtitle text in an image (e.g., closed captioning text). Generally, an OCR mechanism is a computer-implemented process that includes the steps of acquiring an image containing a string of characters to be recognized, recognizing individual characters in the input image as characters of an alphabet, segmenting the characters into one or more strings of characters, and performing a string correction or string recognition mechanism to return a corresponding output string of characters that corresponds to one or more model strings that are searched for in the image (e.g., license plate numbers, serial numbers, postal codes, addresses, etc.).

OCR has a wide range of applications including the recognition of vehicle license plate numbers (e.g., for use in automated traffic law enforcement, surveillance, access control, tolls, etc.), the recognition of serial numbers on parts in an automated manufacturing environment, the recognition of labels on packages (e.g., pharmaceutical packaging, food and beverage packaging, household and personal products packaging, etc.), and various document analysis applications.

Despite sophisticated OCR techniques, OCR errors can occur due to the non-ideal conditions of image acquisition, the partial occlusion or degradation of the depicted characters, and the structural similarity between certain characters (e.g., Z and 2, 0 and D, 1 and I). As one example, the difficulty in recognizing vehicle license plate numbers captured in an image is increased because lighting conditions can vary (according to the time of day, weather conditions, etc.) and are non-uniform (e.g., due to shadows and specular reflection), perspective distortion, and partial occlusion or degradation of the characters (e.g., due to mud, wear of the paint, etc.).

To improve the overall performance of OCR systems, a post-processing stage is performed, during which OCR errors are automatically detected and corrected. A popular technique to automatically correct errors in words is “dictionary lookup”: an incorrect word, that is, one that does not belong to a predefined “dictionary” of valid words, is replaced by the closest valid word in the dictionary. This is often achieved by selecting the dictionary word yielding the minimum “edit distance” with the incorrect word. The edit distance between two strings is the minimum number of edit operations (deletions, insertions, and substitutions) needed to transform the first string into the second string. In some techniques, the edit distance has been generalized to an edit cost by assigning a weight to an edit operation according to the type of operation, the character(s) of the alphabet involved in the operation and/or recognition scores.

Current optical string recognition systems detect and correct various types of OCR errors. For example, current optical string recognition systems can recognize a candidate string identified in the image as a match for a model string and return a corresponding output string where: the candidate string includes an extra character where there is no character in the model string (e.g., before a first character, after a last character, or between characters of the model string); the candidate string includes a non-blank character where there is a blank character in the model string; and the candidate string includes an incorrectly matched character at a character position where a valid character was also matched.

However, existing optical string recognition systems do not properly address candidate strings that are missing a character or include an invalid character at a character position where no alternative valid character was matched. Existing optical string recognition systems fail to read the string altogether in the preceding circumstances and do not return any characters. The preceding occurs even where some characters included in the candidate string properly match those in the model string.

In addition, existing optical string recognition systems do not address the case where the model string includes an optional character, i.e., a character that a candidate string should preferably include but is not required to include to be considered a valid match for the model string.

### SUMMARY OF INVENTION

Therefore, there is a need for methods, systems and apparatus that identify a partial match between a candidate string identified in an image and a model string. These approaches provide apparatus and systems that provide feedback to a user when a partial match is identified. This allows the user to adjust parameters of the optical string recognition system until a full match is identified.

According to one aspect, methods for recognizing (reading), in an image, a string of characters satisfying the constraints of a model string are provided. According to various embodiments, the method includes identifying one or more candidate strings of characters in the image using optical character recognition; comparing each of the candidate strings with the model string using, as a difference measure, a minimum edit cost determined between the candidate string and the model string (where the minimum edit cost calculates a cumulative cost of edit operations required to transform the candidate string to satisfy the constraints of the model string); processing the minimum edit costs of the candidate strings to identify a match for the model string among the candidate strings; and returning an output string corresponding to the match. According to some embodiments, the preceding includes additional edit operations and their associated special edit costs to return an identification of a partial match. According to other embodiments, the preceding includes additional edit operations and their associated special edit costs to return an identification of a basic match.

According to one embodiment, the matching of a candidate string that partially matches a model string is successfully performed where the image does not include any candidate string that fully matches the model string. According to this embodiment, a minimum edit cost is successfully determined where the candidate string includes a missing or invalid character. Under this condition, the minimum edit cost includes a special cost for an edit operation for identifying a missing character. The special cost is significantly higher than the edit costs of other types of edit operations. The minimum edit cost including the special cost is significantly higher than any minimum edit cost without the special cost. A partial candidate string corresponding to a minimum edit cost including the special cost is selected as a match for the model string only where there was no minimum edit cost without the special cost. That is, where there was no full candidate string.

According to another embodiment, a basic (minimum-requirement) string is returned as an output string when no full (full-requirement) string is matched in the image. According to this embodiment, a minimum edit cost is determined where the model string includes an optional character position. Under this condition, the minimum edit cost includes a special cost for an edit operation for indicating the skip of an optional character position of the model string. Here too, the special cost is significantly higher than the edit costs of other types of edit operations and, therefore, the minimum edit cost including the special cost is significantly higher than any minimum edit cost without the special cost. Accordingly, a basic candidate string corresponding to a minimum edit cost including the special cost is selected only where there was no minimum edit cost without the special cost. That is, where there was no full candidate string.

Further, embodiments described herein integrate methods, systems and apparatus having this new functionality into the existing optical string recognition process with minimal changes. For example, by updating certain operations within the existing process flows to include the new functionality while otherwise maintaining the existing process flow.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a block diagram of an optical string recognition system in accordance with one embodiment;

FIG. 2 illustrates a flow diagram of an optical string recognition process for detecting candidate strings in an image and processing the candidate strings to identify a match for a model string in the image where a candidate string includes a missing or invalid character in accordance with one embodiment;

FIG. 3 illustrates images, candidate strings identified in the images using optical character recognition, and resulting output strings where a candidate string includes a missing or invalid character in accordance with one embodiment;

FIG. 4 illustrates a process flow diagram in accordance with an embodiment of the process illustrated in FIG. 2 where a blank character is detected at a character position in the candidate string that corresponds to a character position having a non-blank character in the model string;

FIG. 5 illustrates a dynamic programming array (DPA) for performing dynamic programming to compute a minimum edit cost between a candidate string and a model string in accordance with one embodiment where there is a detected blank character at a character position in the candidate string and a non-blank character at a corresponding character position in the model string;

FIG. 6 illustrates a process flow diagram in accordance with an embodiment of the process illustrated in FIG. 2 where a missing or invalid character is detected at a character position in the candidate string with respect to a character position in the model string;

FIG. 7 illustrates a dynamic programming array (DPA) for performing dynamic programming to compute a minimum edit cost between a candidate string and a model string in accordance with one embodiment where a missing or invalid character is detected at a character position in the candidate string with respect to a character position in the model string;

FIG. 8 illustrates a dynamic programming array (DPA) for performing dynamic programming to compute a minimum edit cost between a candidate string and a model string in accordance with an embodiment where a missing or invalid character is detected at an initial or a final character position in the candidate string;

FIG. 9 illustrates a process flow diagram in accordance with an embodiment of the process illustrated in FIG. 2 where there is a link character, which links two shorter candidate strings, at a character position in the candidate string and a non-blank character at a corresponding character position in the model string;

FIG. 10 illustrates a dynamic programming array (DPA) for performing dynamic programming to compute a minimum edit cost between a candidate string and a model string in accordance with an embodiment where there is a link character at a character position in the candidate string and a non-blank character at a corresponding character position in the model string;

FIG. 11 illustrates a flow diagram of an optical string recognition process for detecting candidate strings in an image and processing the candidate strings to identify a match for a model string in the image where the model string includes one or more optional character positions in accordance with one embodiment;

FIG. 12 illustrates images, candidate strings identified in the images using optical character recognition, and resulting output strings where the model string includes optional character positions in accordance with one embodiment;

FIG. 13 a dynamic programming array (DPA) for performing dynamic programming to compute a minimum edit cost between a candidate string and a model string in accordance with one embodiment where the model string includes optional character positions; and

FIG. 14 illustrates a block diagram illustrating a data processing system that may be used in accordance with some embodiments.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

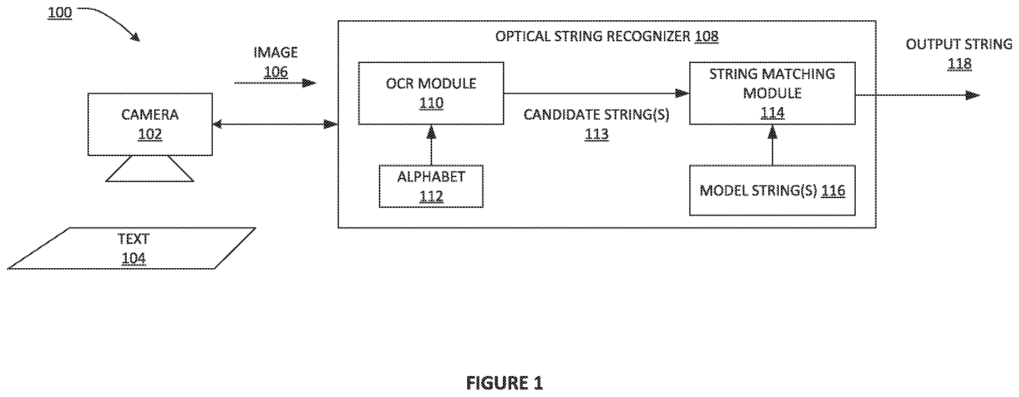

Referring now to FIG. 1, an optical string recognition system 100 is illustrated in accordance with various embodiments. According to the illustrated embodiment, the system 100 includes an image acquisition device 102 (for example, a camera) and an optical string recognizer 108. According to the illustrated embodiment, the optical string recognizer 108 includes an OCR module 110, an alphabet 112, candidate strings 113, a string matching module 114 and one or more model string(s) 116. In general, the system 100 operates to capture, using the the image acquisition device 102, an image 106 of an object that includes text 104. The optical string recognizer 108 processes the image to provide an output string 118 corresponding to the text 104.

Referring now to FIG. 1, an optical string recognition system 100 is illustrated in accordance with various embodiments. In various embodiments, the optical string recognition system 100 operates to recognize (read) text 104 to provide an output string 118. According to various embodiments, the optical string recognition system 100 may be used for reading vehicle license plate numbers, serial numbers on parts in a manufacturing environment, labels on packaging, and various types of documents.

According to the illustrated embodiment, the system 100 includes an image acquisition device 102 and an optical string recognizer 108. In some embodiments, the image acquisition device 102 and optical string recognizer 108 are included in a single housing, such as a machine vision camera (smart camera). In other embodiments, the image acquisition device 102 and optical string recognizer 108 are separate devices (e.g., in a same location or remote from one another) that communicate using a wired or wireless connection.

In general, the system 100 operates to capture, using the image acquisition device 102, an image 106 of an object or scene that includes text 104 for processing by the optical string recognizer 108. According to various embodiments, the image acquisition device 102 can include a digital camera, video camera, scanner or other suitable device for acquiring images. According to various embodiments, the image may be a binary, grayscale or color image; the image may be a still image or a frame from a video sequence.

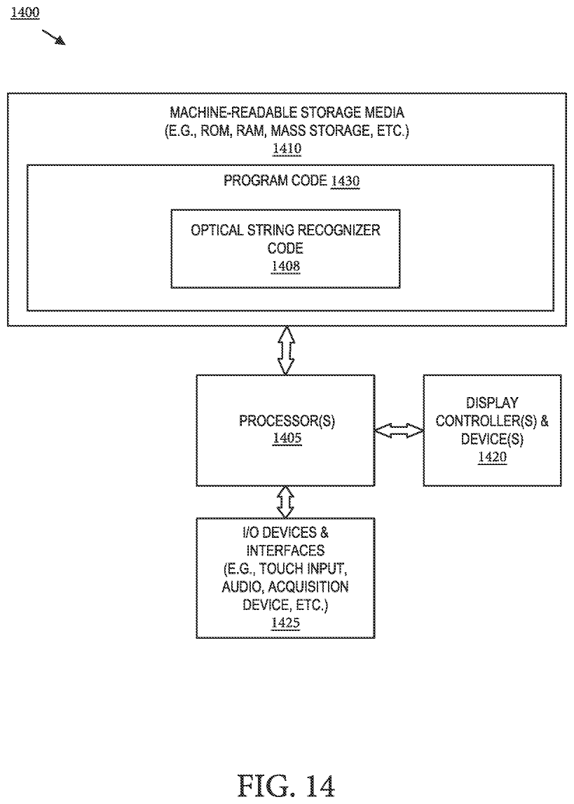

The optical string recognizer 108 analyzes the image 106 to provide an output string 118 corresponding to the text 104. In various embodiments, the optical string recognizer 108 is implemented in an electronic device as is described in greater detail with reference to FIG. 14. According to the illustrated embodiment, the optical string recognizer 108 includes an OCR module 110, an alphabet 112, candidate string(s) 113, a string matching module 114 and one or more model string(s) 116.

The OCR module 110 performs optical character recognition (OCR) on the image 106 using an alphabet 112 to identify one or more candidate strings of characters 113 for processing by the string matching module 114. According to some embodiments, the OCR module 110 finds candidate characters in the image 106 using OCR and then segments the candidate characters into one or more candidate strings.

In various embodiments, an alphabet includes a set of characters (e.g., letters, digits, punctuation, etc.). In some embodiments, each character of the alphabet has a corresponding model, such as a model image or model feature vector representing the alphabet character for matching purposes. Generally, a candidate character is a portion of the image that is a potential occurrence of a character of the alphabet 112. In some embodiments, a candidate character includes associated information such as the character of the alphabet that was matched (e.g., the letter 13′), a match confidence score (e.g., 98%) and a position in the image (e.g., the x and y coordinates in pixels, integer or subpixel).

Depending on the embodiment, the OCR module 110 can employ any of a variety of pattern matching techniques to find the candidate characters in the image 106. In some embodiments, the OCR module 110 employs a model-based OCR method that locates the occurrence of a model (e.g., model image) of the alphabet character. Some model-based OCR techniques extract a set of features from a portion of the image and compare it with a set of features representing the alphabet character using a difference measure. Other model-based OCR techniques compare values of pixels (e.g., pixel intensities) in a portion of the image with values of pixels in a model image of the alphabet character using normalized grayscale correlation, for example. Other model-based OCR techniques extract a set of features from the image and determine associations between the extracted set of features and a reference set of features representing the alphabet character. For example, the set of features can be the coordinates of edge points, interest points or other local features. Pattern matching techniques based on geometric hashing, the Hough transform, or generalized Hough transform may be employed, as just some examples. In other embodiments, the OCR module 110 employs an artificial-intelligence based OCR method that does not use a model at runtime but is trained using a suitable training set of samples.

In some embodiments, a single candidate character is retained at a position in the image, e.g., only the candidate character with the highest score. In other embodiments, multiple candidate characters are retained at a same position or around a same position in the image. In some implementations, occurrences of characters having a confidence score below an acceptance threshold are not retained as candidate characters.

Once candidate characters have been detected, the OCR module 110 segments the candidate characters into one or more candidate strings using a “stringness” criterion, such as an alignment criterion and or an inter-character spacing criterion. An alignment criterion requires that, within a candidate string, candidate characters must be aligned within an acceptable tolerance. An inter-character spacing criterion requires that, within a candidate string, the distance between two consecutive candidate characters must be smaller than a maximum inter-character distance (dmax).

In some embodiments, candidate characters are grouped into lines based on the alignment criterion and then candidate characters within a line are grouped into candidate strings based on the inter-character spacing criterion. For example, a distance (d) between consecutive candidate characters is compared with the maximum inter-character distance dmax: if d is larger than dmax, the candidate characters are grouped into separate candidate strings; if d is smaller than or equal to dmax, the candidate characters are grouped into the same candidate string.

In some embodiments, the optical string recognizer 108 can recognize strings including spaces or blanks. In this case, according to some embodiments, the OCR module 110 can detect blank characters within candidate strings as part of the segmentation step. Returning to the example described above, in this case, the distance (d) is also compared with a minimum space length (dmin): If d is smaller than dmin, the candidate characters are considered adjacent (no space) within a same candidate string; if d is between dmin and dmax, a blank candidate character is detected between the candidate characters within a same candidate string; and if d is larger than dmax, the candidate characters are grouped into separate candidate strings.

According to some embodiments, a candidate string comprises a sequence of candidate characters, each having an associated position in the image. In other embodiments, a candidate string comprises a sequence of sets of candidate characters, each set of candidate characters located at a related position in the image. In some embodiments, the set of candidate characters can includes a primary candidate character having the highest recognition score among the set and one or more secondary candidate characters having lower recognition scores.

In some embodiments, as is described in greater detail below, smaller or “micro” candidate strings that satisfy the inter-character spacing criterion can be joined with “link” characters to form a larger or “macro” candidate string that does not satisfy the inter-character spacing criterion. In these embodiments, both the micro and macro candidate strings are included in the one or more candidate strings 113 provided to the string matching module 114.

Returning to FIG. 1, the OCR module 110 provides the one or more candidate strings to the string matching module 114. In various embodiments, the string matching module 114 processes the one or more candidate strings 113 to determine whether there is a match for one or more model strings 116. In some embodiments, the string matching module 114 identifies, among the one or more candidate strings 113, a best match for a model string.

According to various embodiments, a model string specifies a valid output string or a valid format (or “template”) for an output string. Depending on the embodiment, a model string may be preconfigured or provided by a user.

According to some embodiments, a model string specifies, for each character position in an output string, a single valid character for the character position: MS=c1 c2. where ci is a character of the alphabet. Generally, according to these embodiments, for an output string to be valid, each character of the output string must match the character at the corresponding character position of the model string.

According to some embodiments, a model string specifies, for each character position in an output string, a set of valid characters for the character position: MS=C1 C2. where Ci is a set of characters of the alphabet. Generally, according to these embodiments, for an output string to be valid, each character of the output string must belong to the set of characters at the corresponding character position of the model string.

According to some embodiments, a model string can include a blank character between consecutive non-blank characters. Generally, in these embodiments, for an output string to be valid, the output string must include a blank space having a width within the range (Dmin, Dmax) at the same character position as in the model string, where (Dmin, Dmax) are minimum and max widths of a blank predefined for the model string.

According to some embodiments, as is described in greater detail below, a model string includes one or more optional character positions. Generally, in these embodiments, for an output string to be valid, the output string must satisfy the constraint of the model string at each of the required (non-optional) character positions.

Returning again to FIG. 1, the string matching module 114 evaluates and compares the one or more candidate strings 113 to determine a match for a model string 116 by determining a minimum edit cost between each candidate string and the model string, respectively. For a single candidate string, this results in a single minimum edit cost. In the case of multiple candidate strings, this results in a set of minimum edits costs, one for each of the candidate strings.

The minimum edit cost between a candidate string and a model string is the minimum cost of edit operations performed on the candidate string to transform it into a valid output string that satisfies the constraints of the model string. Generally, possible edit operations include deletions, insertions and substitutions, as is described further below. In the context of OCR, depending on the embodiment, the edit costs can be assigned based on the type of edit operation, the particular characters of the alphabet involved in the edit operation and/or the OCR recognition scores of the associated candidate characters.

In various embodiments, an edit operation is allowed only if a corresponding condition is met. If the condition is met, the edit operation is allowed and the cost of the edit operation is included in the determination of the minimum edit cost. Although the edit operation is considered, it may not be retained in the final minimum edit cost, if another set of edit operations yielded a smaller edit cost.

According to some embodiments, as will be described in greater detail below, new edit operations are included in the set of possible edit operations used in the determination of the minimum edit cost between a candidate string and a model string. Each of these new edit operations has a respective condition that must be satisfied for the respective edit operation to be allowed and a respective special edit cost that is included in the determination of the minimum edit cost if the condition is satisfied. Including these new edit operations provides new functionality not provided by existing optical string recognition processes.

According to some embodiments, the minimum edit cost is determined using a dynamic programming approach that determines a minimum edit cost at each cell of a DPA table. According to these embodiments, the new edit operations, with their respective condition and respective special cost, are considered in the determination of the minimum edit cost at each cell, as with other edit operations.

Returning to FIG. 1, based on the set of minimum edits costs, one for each of the candidate strings, the string matching module 114 determines whether there is a match for the model string among the set of candidate strings. If a match is found, the string matching module 114 then returns an output string corresponding to the matched candidate string.

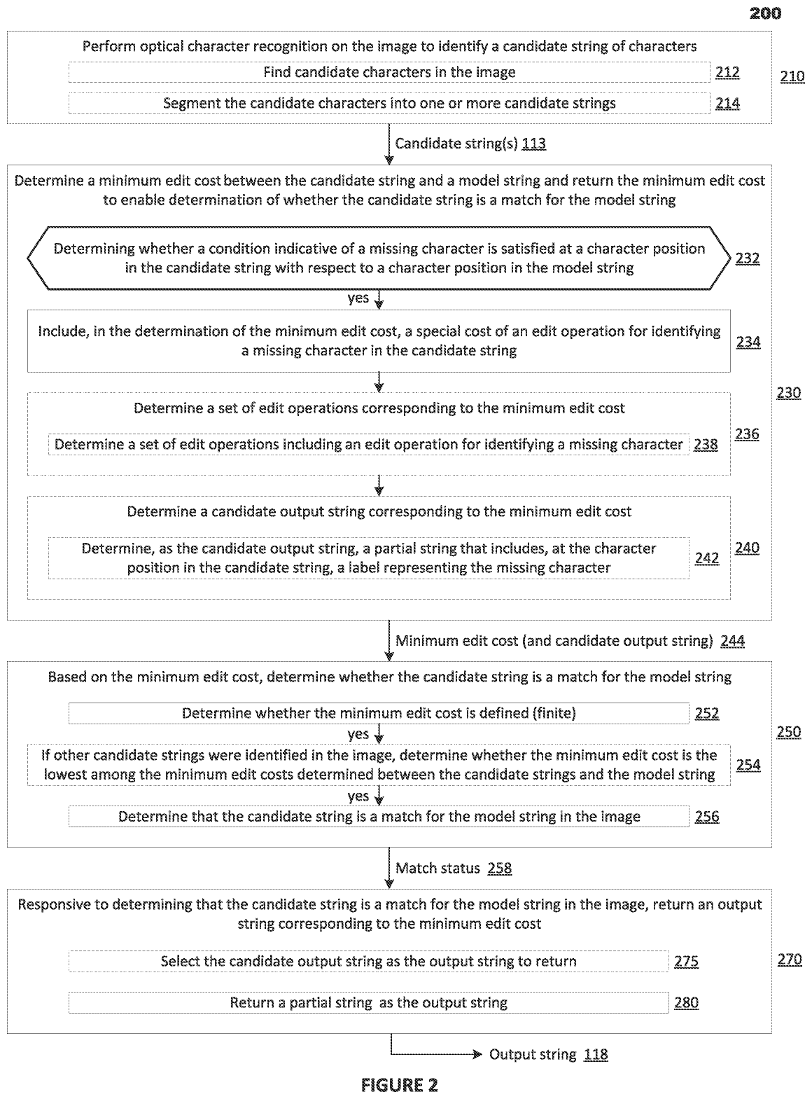

Referring to FIG. 2, a flow diagram of a process 200 for optical character recognition and string matching is illustrated in accordance with some embodiments. According to the illustrated embodiment, the process 200 operates to detect candidate strings in an image, to process the candidate strings, to identify a match for a model string in the image and, where a match is identified, returning an output string in circumstances where a candidate string includes a missing or invalid character. The process 200 includes four primary operations including an act of performing optical character recognition on an image 210, an act of determining a minimum edit cost 230, an act of determining whether a candidate string is a match for a model string 250 and an act of returning an output string 270.

According to the illustrated embodiment, the act of performing optical character recognition on an image 210 includes multiple acts including an act of finding candidate characters in the image 212 and an act of segmenting the candidate characters into one or more candidate strings 214.

According to the illustrated embodiment, the act of determining the minimum edit cost 230 includes multiple acts including an act of determining whether a condition indicative of a missing character is satisfied 232; where the condition is satisfied, an act of including, in the determination of the minimum edit cost, a special cost of an edit operation for identifying a missing character in the candidate string 234; an act of determining a set of edit operations corresponding to the minimum edit cost 236 and an act of determining a candidate output string corresponding to the minimum edit cost 240.

Further, according to the illustrated embodiment, the act of determining whether a candidate string is a match for the model string 250 includes multiple acts including an act of determining whether the minimum edit cost is defined 252, an act of determining whether the minimum edit cost is the lowest among the minimum edit costs 254 and an act of determining that the candidate string is a match for the model string in the image 256.

In addition, according to the illustrated embodiment, the act of returning the output string 270 includes multiple acts including an act of selecting the candidate output string as the output string to return 275 and an act of returning a partial string as the output string 280.

In general, the process 200 begins at the act of performing optical character recognition on the image 210 to provide a candidate string 113 and moves to the act of determining a minimum edit cost 230 to provide a minimum edit cost between the candidate string and a model string 244. The minimum edit cost 244 is employed at the act of determining whether the candidate string is a match for the model string 250 to provide a match status 258 (that is, match found or match not found). The process moves to the act of returning an output string 270 where the match status 258 is processed to provide an output string 118.

The process 200 begins at the act of performing optical character recognition on an image 210. Here, candidate characters are identified in the image 106 at the act of finding candidate characters in the image 212. Then, candidate characters are segmented into candidate strings at the act of segmenting the candidate characters into one or more candidate strings 214. The act of performing optical character recognition on an image 210 is completed and one or more candidate strings 113 are provided for processing at the act of determining the minimum edit cost 230.

The process 200 continues at the act of determining the minimum edit cost 230. At the act of determining whether a condition indicative of a missing character is satisfied 232, each of the one or more candidate strings 113 is evaluated to determine whether a condition indicative of a missing character is satisfied at a character position in the candidate string with respect to the same character position in the model character string. If the preceding condition is identified, the process 200 continues to the act of determining the special cost of an edit operation for identifying the existence of the missing character in the candidate string 234. The process 200 and the act 230 continue at the act 236. Here, according to this embodiment, the set of edit operations including an edit operation for identifying a missing character is determined at an act 238 and the process moves to the act 240. At the act 242, a candidate output string is determined where the candidate output string is a partial string that includes, at the character position in the candidate string, a label representing the missing character.

With the act of determining the minimum edit cost 230 complete, the process 200 continues with the act of determining whether a candidate string is a match for the model string 250. Here, the minimum edit cost and the associated candidate output string 244 are employed beginning at the act of determining whether the minimum edit cost is defined 252. That is, determining whether the minimum edit cost is a finite value (as opposed to an infinite value). For example, an infinite value is returned where a set of edit costs to match a candidate string to a model string does not exist even allowing for edits that result in a special cost. Where the minimum edit cost is defined and where other candidate strings are identified in the image, then the process 200 and the act 230 continue with an act of determining whether the minimum edit cost is the lowest among each of the minimum edit costs determined for any of the candidate strings that are identified. The process 200 moves to an act of determining that the candidate string having the minimum edit cost is a match for the model string in the image 256.

The match status 258 (the identification of the candidate string having the minimum edit cost) is then employed at the act of returning an output string 270. Here, an output string corresponding to the minimum edit cost determined at the act 256 is output to complete the process 200. This includes the act of selecting the candidate string as the output string to return 275. According to this embodiment, the selected candidate output string is a partial output string because it includes at least one character position represented by a label representing a missing character. Following the act 275, the process 200 and the act 270 are completed with the act of returning the partial string as the output string 280. The result is the output string 118.

Unlike prior approaches, the preceding describes a process in which a candidate string is output even where the candidate string is missing one or more characters. To achieve this result, the process 200 includes a number of acts that are either modified or completely new relative to prior approaches. For example, the act 230 includes two new acts. A first new act is provided at the act of determining whether a condition indicative of a missing character is satisfied 232. The second new act is provided at the act of determining a special cost of an edit operation for identifying a missing character in the candidate string 234. These two acts provide a process that is flexible enough to address a missing character because a special edit cost can now be determined in those conditions.

In addition to the new acts, the acts 236 and 240 are each modified with an addition of a new operation, respectively. In the process 200, the act 236 includes the act of determining a set of edit operations including an edit operation for identifying a missing character 238. Here, the cost of the edit operation that identifies a missing character is now determinable. Further, the availability of the cost to identify a missing characters now makes it possible to edit partial candidate strings to include such an identification. This is reflected in the addition of the act of determining a candidate output string where the candidate output string is a partial string that includes, at the character position in the candidate string, a label representing the missing character 242. Finally, at the act 280, the process 200 is operable to return a partial string as the output string, for example, where the partial string is the candidate string having the minimum edit cost.

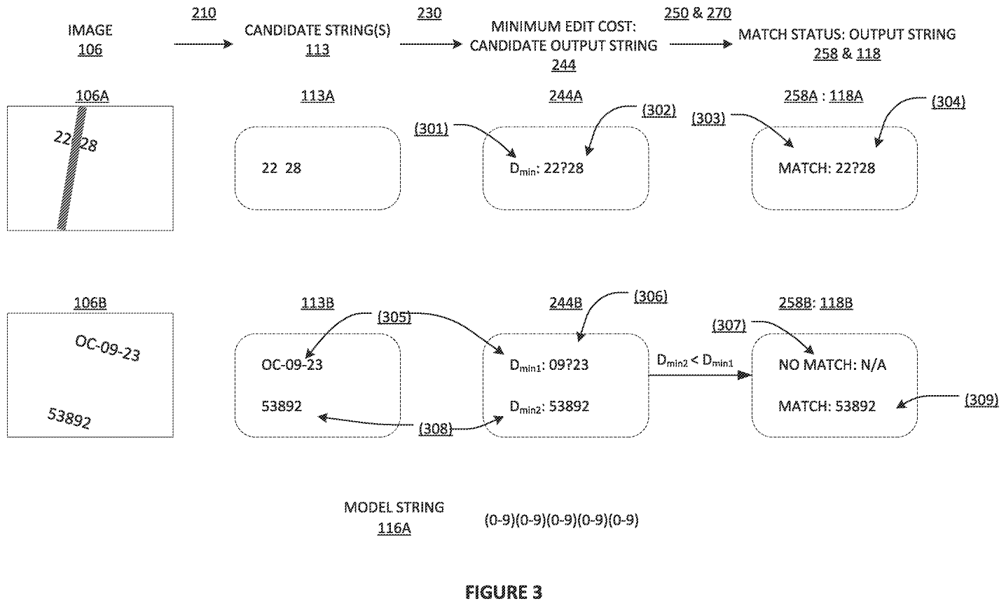

Referring now to FIG. 3, candidate strings identified in images using optical character recognition, a model string and resulting output strings are illustrated in embodiments where a candidate string includes a missing or invalid character. FIG. 3 illustrates two examples, each including a candidate string with a missing or invalid character, with reference to system elements included in FIG. 1 and process steps included in FIG. 2. That is, each example in FIG. 3 includes an image 106; resulting candidate string(s) 113; and, for each candidate string, a minimum edit cost 244, a match status 258 and, where a match is found, an output string 118. The series of operations that are illustrated include the act of performing optical character recognition on the image 210, the act of determining the minimum edit cost 230, the act of determining whether the candidate string is a match for the model string 250 and an act of returning an output string 270. In both examples, the model string 116A includes a five character sequence of digits: “(0-9)(0-9)(0-9)(0-9)(0-9)”.

The first example illustrated in FIG. 3 includes a first image 106A, a first set of candidate strings 113A, a first set of minimum edit costs and corresponding candidate output strings 244A, a first set of match statuses (one for each of the first set of candidate output strings) 258A and a first output string 118A. The first image 106A includes a set of five characters with the third character obscured in the image. The resulting first set of character strings 113A includes a single candidate string “22 28”. Referring again to the process 200 and specifically to the act of determining a minimum edit cost 230, the missing-character condition is satisfied at the third character position in the candidate string “22 28” with respect to the third character position in the model string 116A at the act 232. In this first example, the candidate string includes a blank character where the model string requires a digit (0-9). The first set of minimum edit costs 244A includes a single minimum edit cost Dmin. Here, the minimum edit cost Dmin includes a special edit cost determined at the act 234 where the special edit cost is attributable to an identification of the missing character at the third character position in the candidate string. The corresponding candidate output string “22?28” is a partial string that includes, at the third character position in the candidate string, a label representing the missing character. In the illustrated embodiment, the label takes the form of “?”.

According to the illustrated embodiment, as the first set of candidate strings 113A includes a single candidate string “22 28”, the first set of minimum edit costs 244A includes a single minimum edit cost (Dmin). As a result, although it includes the special cost, the minimum edit cost is, by default, the lowest minimum edit cost among the set of identified candidate strings 113A. The corresponding candidate output string “22?28” which is a partial string is determined to be a match for the model string 116A and returned as the output string 118A.

The second example illustrated in FIG. 3 includes a second image 106B, a second set of candidate strings 113B, a second set of minimum edit costs and corresponding candidate output strings 244B, a second set of match statuses (one for each of the second set of candidate output strings) 258B and a second output string 118B. The second example illustrated in FIG. 3 differs from the first example because optical character recognition performed on the image 106B identifies two candidate strings.

The second set of candidate strings 113B includes a first candidate string “OC-09-23” and a second candidate string “53892”. Consequently, a resulting second set of minimum edit costs and corresponding candidate output strings 244B includes a first minimum edit cost Dmin1 and corresponding first candidate output string “09?23” and a second minimum edit cost Dmin2 and corresponding second candidate output string “53892”.

For the first candidate string “OC-09-23”, the missing-character condition is satisfied at the 6th character position in the candidate string with respect to the third character position in the model string 116A. Here, the candidate string includes an invalid character “−” where the model string requires a digit (0-9). Consequently, a special cost is included in the determination of a first minimum edit cost Dmin1. The corresponding first candidate output string “09?23” is a partial string that includes at a third character position (corresponding to a 6th character position in the original candidate string following 3 character deletions) the label representing the missing character.

For the second candidate string “53892”, the missing-character condition is not satisfied at any character positions and, as a result, the second minimum edit cost Dmin2 does not include any special cost and the second candidate output string “53892” is a full string.

With first and second candidate output strings and an associated first and second minimum output costs, respectively, the process 200 determines for each of the candidate output strings whether the minimum edit cost is the lowest among the plurality of minimum edit costs at the act 270. As noted above, there is a significant special cost for any edit operation that results in a partial character string including a label representing a missing character. Here, the result is that Dmin1 is substantially greater than Dmin2. Consequently, Dmin1 is not the lowest among the minimum edit costs of the candidate strings identified in the image. Instead, the second candidate output string with no missing or invalid characters results in the minimum edit cost (Dmin2) that does not include any special cost and with a complete string as a candidate output string. Because, the minimum edit cost Dmin2 is the lowest minimum edit cost among the identified candidate strings, the second candidate output string “53892” is determined to be a match for the model string at the act 258 and is returned as the output string at the act 118.

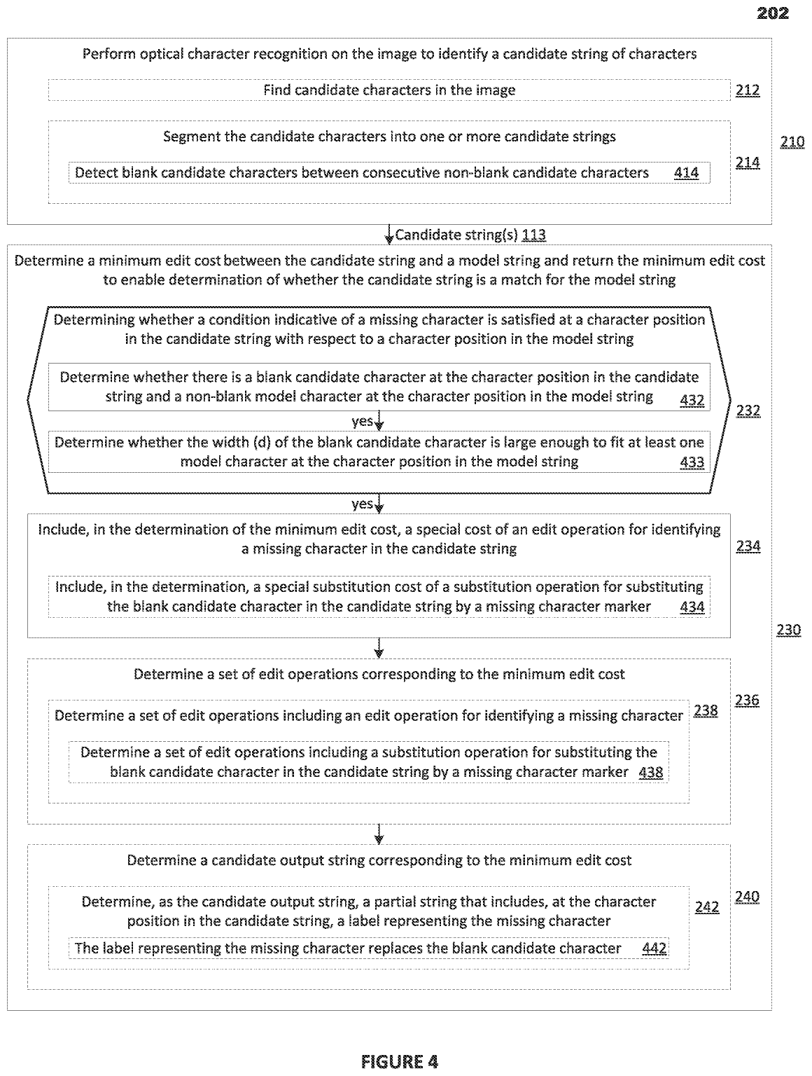

As mentioned above, optical character recognition is performed by recognizing individual characters in the input image as characters of an alphabet. In various embodiments, each alphabet character is represented by a model (e.g, an image of the character) having a width (d) and height. As described with reference to FIG. 4 and the process 200, these widths can be employed to determine whether a blank character in a candidate string can be replaced by the missing character marker.

Referring to FIG. 4, a flow diagram of a process 202 for optical character recognition and determination of a minimum edit cost to enable string matching is illustrated in accordance with some embodiments. The process 202 provides further details of acts included in the process 200 illustrated and described with reference to FIG. 2. For example, further acts are included in the act of performing optical character recognition on the image 210 and those included in the act of determining the minimum edit cost 230 in circumstances where the candidate string includes a blank character at a character position where the model string requires a non-blank character.

According to the illustrated embodiment, at the act of performing optical character recognition on the image 210, the act of segmenting the candidate characters into candidate strings 214 includes an act of detecting a blank candidate character between consecutive non-blank candidate characters 414. At the act of determining the minimum edit cost 230, the act of determining whether a condition indicative of a missing character is satisfied 232 includes an act of determining whether there is a blank candidate character at the character position in the candidate string and a non-blank model character at the character position in the model string 432 and an act of determining whether a width (d) of the blank candidate character is large enough to fit at least one model character at the character position in the model string 433. Further, the act of including, in the determination of the minimum edit cost, a special cost of an edit operation for identifying a missing character in the candidate string 234 includes an act of including, in the determination, a special substitution cost of a substitution operation for substituting the blank candidate character in the candidate string by a missing character marker 434. Also, the act of determining a set of edit operations corresponding to the minimum edit cost 236 includes an act of determining a set of edit operations including a substitution operation for substituting the blank candidate character in the candidate string by a missing character marker 438. The act of determining a candidate output string corresponding to the minimum edit cost 240 includes an act of determining, as the candidate output string, a partial string in which the blank candidate character is replaced with a label representing the missing character 442. The act of determining the minimum edit cost 230 completed, the minimum edit cost (e.g., including the special substitution cost for substituting the blank candidate character by a missing character marker) and the corresponding candidate output string (e.g., a partial string) are returned to enable determination of whether the candidate output string is a match for the model string, such as described previously with reference to FIGS. 1 and 2.

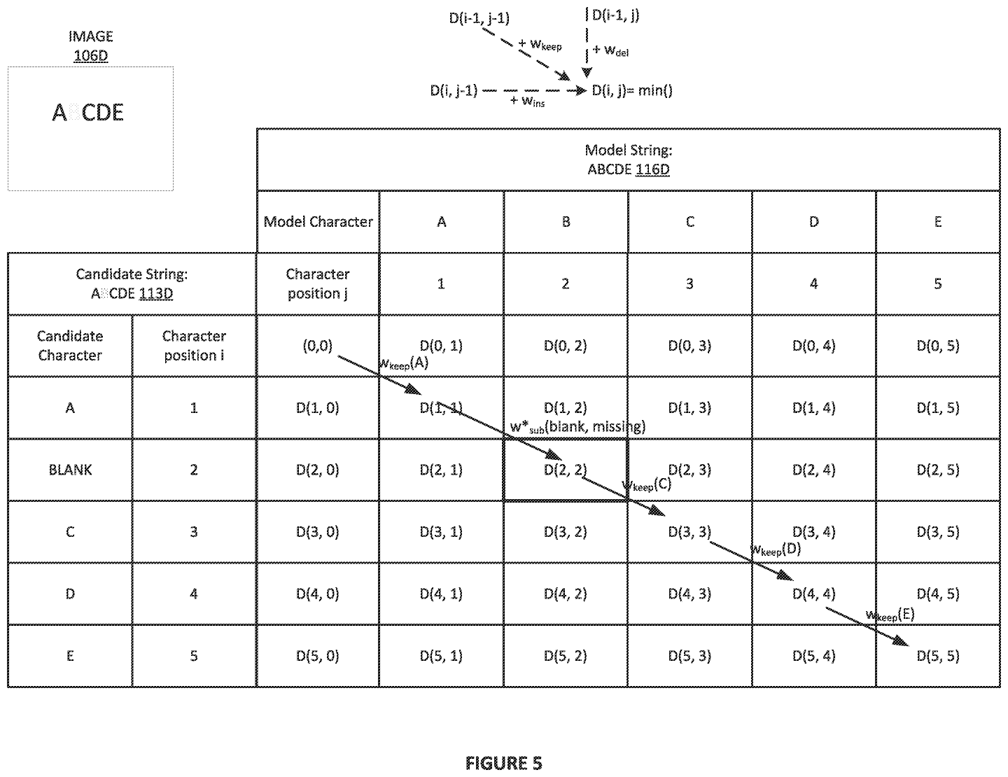

Referring now to FIG. 5 a dynamic programming array (DPA) for calculating the minimum edit cost between a candidate string 113D “A CDE” (including a blank candidate character at a second character position) and a model string 116D “ABCDE” including no blanks is illustrated in accordance with one embodiment. The DPA of FIG. 5 includes an array of cells. The DPA array is completed by iteratively calculating the minimum edit cost D(i,j) for each cell (i,j), starting at the top-left cell (0,0) and ending at the bottom-right cell (M, N), which is the overall minimum cost between the two strings. At each cell, the minimum edit cost D(i, j) is determined as the minimum of the edit costs for each of the viable paths.

The operations illustrated in FIG. 5 are described here with reference to the process 202 illustrated and described with reference to FIG. 4. In overall operation the minimum edit cost for a candidate string is determined by processing, in turn, each cell (i,j) of the dynamic programming array, proceeding generally from the top-left cell (0,0) to the bottom right cell (5,5). For a given cell (i,j) corresponding to character position i and candidate character CCi of the candidate string and output character position j and model character Cj of the model string, the minimum edit cost D(i,j) is determined. Operations available when calculating the minimum edit cost via the DPA are represented by the vectors illustrated at the top of FIG. 5. These vectors include a “keep” vector wₖₑₑₚ, a “delete” vector+w_{del} and an “insert” vector+wᵢₙₛ. Directionally, the keep vector is a diagonal vector in the array directed toward Dmin and cell D(i,j) from cell D(i-1, j-1). The delete vector is a vertical vector in the array directed toward Dmin and cell D(i,j) from cell D(i-1, j). The insert vector is a horizontal vector in the array directed toward Dmin and cell D(i,j) from cell D(i, j-1). The preceding methodology is common to each embodiment of the DPAs illustrated and described herein.

To begin, the minimum edit cost D(1,1) at cell (1,1) is determined using the cost wkeep of a keep operation of the candidate character “A” at the first character position (i=1) of the candidate string to match the model character “A” at the first character (j=1) of the model string. To determine the minimum edit cost D(2,2) at cell (2,2), it is determined whether it is possible to proceed diagonally from D(1,1) by performing a keep or substitution operation. At act 414 a blank candidate character is detected between non-blank candidate characters (the blank located between the “A” and the C″). Here, since D(i,j) is defined and the conditions of acts 432 and 434 are satisfied, the minimum edit cost D(2,2) is calculated as the minimum of the edit costs for each of the viable paths including the edit cost of proceeding diagonally from cell (1,1) by adding D(1,1) and the special substitution cost w*sub(blank, missing). For example, the special substitution cost determined at the act 434. In this example, this path yields the smallest edit cost and therefore D(2,2)=D(1,1)+w*sub(blank, missing). The rest of the DPA array is completed with three successive keep operations corresponding to character positions 3, 4 and 5 of the string. The first of these keep operations proceeds from cell D(2,2) to D(3,3) where the candidate character “C” is kept. The second keep operation proceeds from cell D(3,3) to D(4,4) where the candidate character “D” is kept. The third and final keep operation proceeds from cell D(4,4) to D(5,5) where the candidate character “E” is kept.

According to this embodiment, the set of edit operations corresponding to the minimum edit cost (which can be obtained by backtracking through the DPA array) is determined to be, at act 438: keep(A), substitute(blank, missing), keep(C), keep(D) and keep(E). Because the set of edit operations includes the substitution operation for substituting the blank candidate character in the candidate string by a missing character marker, the candidate output string is a partial string. That is, the partial string “A?CDE”. This partial string includes a label “?” inserted at the act 442 representing the missing character at the second character position in the candidate string instead of the blank candidate character. The minimum edit cost Dmin (which is high due to the special cost) and partial candidate output string are returned for processing to determine whether the partial string “A?CDE” has the lowest minimum edit cost among all of the candidate character strings identified in the image (provided that more than one candidate character string is identified). According to various embodiments, the substitution of a missing character marker in the candidate string instead of the blank candidate character improves the OCR system relative to prior approaches because it allows a finite edit cost to be determined even in circumstances where a blank appears in a candidate string at a location where a character appears in the model string.

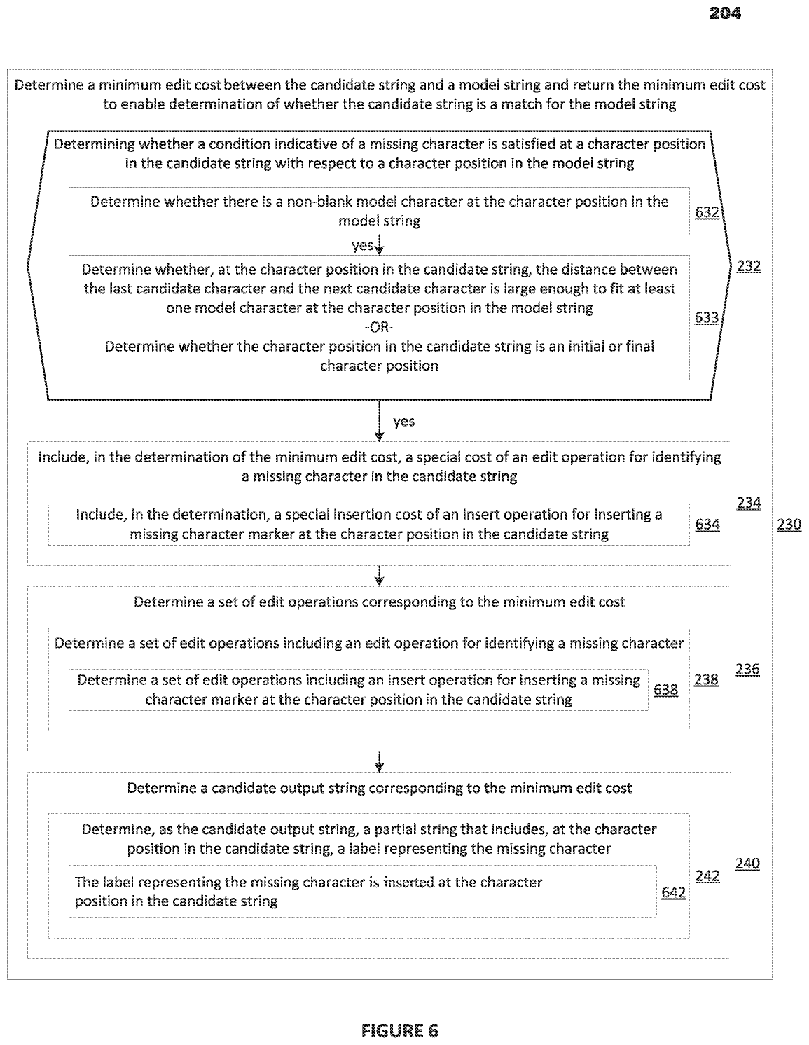

Referring to FIG. 6, a flow diagram of a process 204 for determination of a minimum edit cost to enable string matching is illustrated in accordance with some embodiments. The process 204 provides further details of acts included in the process 200 illustrated and described with reference to FIG. 2. In particular, the process 204 provides further details of acts included in the act of determining the minimum edit cost 230 in circumstances where a missing or invalid character is detected at a character position in the candidate string with respect to a character position in the model string.

According to the embodiment illustrated in FIG. 6, at the act of determining the minimum edit cost 230, the act of determining whether a condition indicative of a missing character is satisfied 232 includes an act 632 of determining whether there is a non-blank model character at the character position in the model string and an act 633 of determining whether either of the following conditions is satisfied: (1) at the character position in the candidate string, the distance between the last candidate character and the next candidate character is large enough to fit at least one model character at the character position in the model string or (2) the character position in the candidate is an initial or a final character position. Further, the act of including, in the determination of the minimum edit cost, a special cost of an edit operation for identifying a missing character in the candidate string 234 includes an act of including, in the determination, a special insertion cost of an insert operation for inserting a missing character marker at the character position in the candidate string 634. Also, the act of determining a set of edit operations corresponding to the minimum edit cost 236 includes an act of determining a set of edit operations including an insert operation for inserting a missing character marker at the character position in the candidate string 638. The act of determining a candidate output string corresponding to the minimum edit cost 240 includes an act of determining, as the candidate output string, a partial string in which a label representing the missing character 642 is inserted at the character position in the character string. The act of determining the minimum edit cost 230 completed, the minimum edit cost (e.g., including the special insertion cost for inserting a missing character marker) and the corresponding candidate output string (e.g., a partial string) are returned to enable determination of whether the candidate output string is a match for the model string, such as described previously with reference to FIGS. 1 and 2.

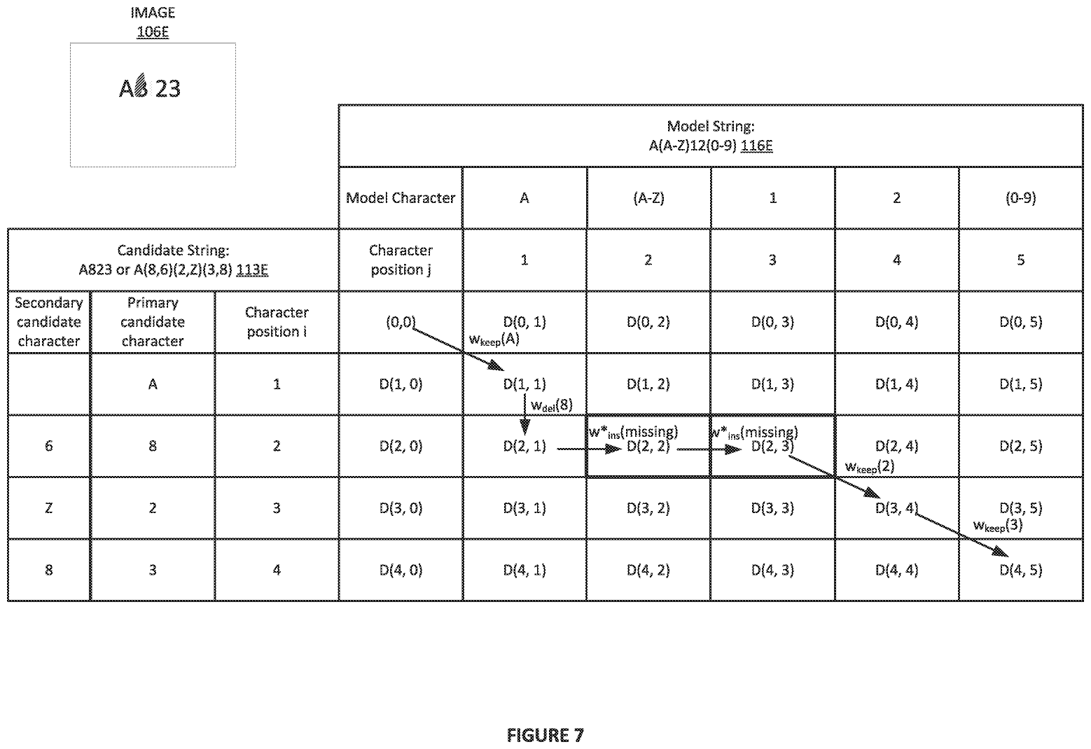

Referring now to FIG. 7, a DPA employed to calculate the minimum edit cost between a candidate string 113E “A823” or “A(8,6)(2,Z)(3,8)” (when including secondary candidate characters) identified in an image 106E and a model string 116E “A(A-Z)12(0-9)” is illustrated in accordance with one embodiment. According to the illustrated embodiment, the candidate string “A823” can also be represented by “A(8,6)(2,Z)(3,8)” when secondary candidate characters are included. The operations illustrated in FIG. 7 are described here with reference to the process 204 illustrated and described with reference to FIG. 6.

To begin the calculation with the DPA, the minimum cost D(1,1) is obtained at cell (1,1) by proceeding diagonally from cell (0,0) with the cost wₖₑₑₚ(A) of a keep operation of the candidate character “A” at the first character position (i=1) of the candidate string to match the model character “A” at the first character (j=1) of the model string. The minimum edit cost D(2,1) is obtained at cell (2,1) by proceeding downwards from cell (1,1) (following the keep operation) with the cost w_{del}(8) of a delete operation of the set of candidate characters “8” and “6” at the second character position (i=2) of the candidate string (because neither belongs to the character set (A-Z) at the second character position (j=2) of the model string).

To calculate the minimum edit cost D(2,2) at cell (2,2), it is first determined whether it is possible to proceed horizontally from cell (2,1) (following the keep and delete operations) by performing an insert operation of a missing character marker. For this, it is determined whether conditions at the 632 and the act 633 are satisfied. That is, at the act 632 whether there is a non-blank model character (A-Z) at the character position j=2 in the model string. Also, at the act 634 following the deletion of the set of candidate characters “8” and “6” at the character position i=2 in the candidate string, whether there is enough space between the previous candidate character “A” and the next candidate character “2” to insert at least one of the model characters (A-Z) at the character position in the model. In the illustrated embodiment, both conditions are satisfied and D(2,1) is defined. The minimum edit cost D(2,2) is calculated as the minimum of the edit costs for each of the viable paths to cell (2,2) including the edit cost of proceeding horizontally from cell (2,1) by adding D(2,1) and the special insertion cost w*ᵢₙₛ (missing). In this example, this path yields the smallest edit cost determined as D(2,2)=D(2,1)+w*i ns (missing).

Then, to calculate the minimum edit cost D(2,3) at cell (2,3), it is determined whether it is possible to proceed horizontally from cell (2,2) (following the previously completed keep operation, delete operation and insert operation) by performing another insert operation of a missing character marker. Here too, it is determined whether conditions of acts 632 and 633 are satisfied. At the act 632, it is determined that a non-blank model character (1) is located at the character position j=3 in the model string. At the act 633, it is determined whether there is still enough space between the previous candidate character “A” and the next candidate character “2” to insert the model character (1) at the character position j=3 in the model string. This determination is made following the insertion of the missing character marker at the character position i=2 (assumed to have a width equal to the width of the thinnest model among the model characters (A-Z)) in the candidate string.

With both conditions satisfied and D(2,2) defined, at the act 634, the minimum edit cost D(2,3) is calculated as the minimum of the edit costs for each of the viable paths to cell (2,3) including the edit cost of proceeding horizontally from cell (2,2) by adding D(2,3) and the special insertion cost w*ᵢₙₛ (missing). In this example, this path again yields the smallest edit cost and therefore D(2,3)=D(2,2)+w*ᵢₙₛ(missing). The array is completed with two successive keep operations corresponding to character positions 4 and 5 of the string. The first of these keep operations proceeds from cell D(2,3) to D(3,4) where the numeric candidate character “2” is kept. The second keep operation proceeds from cell D(3,4) to D(4,5) where the numeric candidate character “3” is kept.

Referring again to FIG. 6, the immediately preceding example includes at act 638 a determination that the set of edit operations includes an insert operation for inserting a missing character marker at two character positions in the candidate string. Here, the set of operations includes keep(A), delete(8), insert(missing), insert(missing), keep(2) and keep(3). At act 642, included in the act of determining a candidate output string corresponding to the minimum edit cost 240, a set of edit operations includes the insert(missing) operation, the candidate output string is a partial string. That is, the partial string “A??23” includes the missing character label “?” at both character position 2 of the candidate string (in the space resulting from deleting the invalid character 8) and at a new character position between original character positions 2 and 3 of the candidate string (the space was present in the original image but was not wide enough to be detected as a blank candidate character). The minimum edit cost Dmin is high due to the special cost associated with two insert(missing) operations. The partial candidate output string “A??23” is returned for a determination of whether the candidate string 113E “A823” is a match for the model string 116E “A(A-Z)12(0-9)” in the image 106E, see act 250 in FIG. 2.

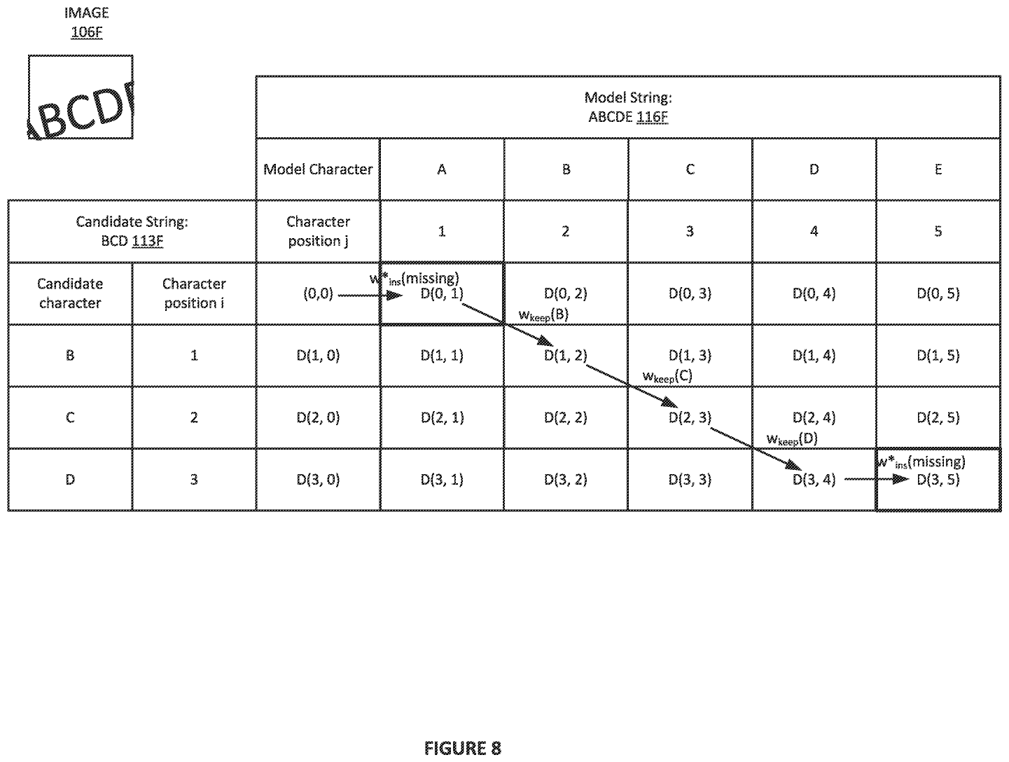

The embodiments described herein can be employed to identify a missing character label at any character position in a candidate character string and insert a missing character label its place. Referring to FIG. 8, the process 204 is employed in combination with a DPA to calculate the minimum edit cost between a candidate string 113F “BCD” identified in an image 106F and a model string 116F “ABCDE”. The candidate string 113F lacks an initial character and a final character because they are located beyond the outer edges of the image 106F. Thus, the candidate string has fewer characters than required by the model string. As a result, candidate characters at character positions 1-3 of the candidate string do no match the model characters at character positions 1-3 of the model string.

To begin the calculation with the DPA, the minimum edit cost D(0,1) at cell (i=0, j=1) is determined. This includes determining whether it is possible to proceed horizontally from cell (0,0) to cell (0,1) by performing an insert operation of a missing character marker. For this, it is determined whether conditions of acts 632 and 633 are satisfied for cell (0, 1). That is, at the act 632, it is determined that a non-blank model character “A” is located at the character position j=1 in the model string. At the act 633, it is determined that the character position is a first character position i=0 in the candidate string. Because both conditions are satisfied and D(0,0) being null is defined the minimum edit cost D(0,1) is calculated as the sum of the edit cost D(0,0)=0 and the special insertion cost w*ᵢₙₛ (missing): D(0,1)=D(0,0)+w*ᵢₙₛ (missing)=w*ᵢₙₛ (missing). According to the illustrated embodiment, this was the only path to reach cell (0,1). The array is navigated with three successive keep operations of candidate characters that follow this insert operation. The first of these keep operations proceeds from cell D(0,1) to D(1,2) where the candidate character “B” is kept. The second keep operation proceeds from cell D(1,2) to D(2,3) where the candidate character “C” is kept. The third keep operation proceeds from cell D(2,3) to D(3,4) where the candidate character “D” is kept.

Then, to calculate the minimum edit cost D(3,5) at cell (i=3, j=5), it is determined whether it is possible to proceed horizontally from cell (3,4) to cell (3,5) by performing another insert operation of a missing character marker. Here too, it is determined whether conditions of the act 632 and the act 633 are satisfied for cell (3,5). At the act 632, it is determined that a non-blank model character “E” is located at the character position j=5 in the model string. At the act 633, it is determined that this is a final character position i=3 in the candidate string. Because both conditions are satisfied and D(3,4) is defined, the minimum edit cost D(3,5) is calculated as the sum of the edit cost D(3,4) and the special insertion cost w*ᵢₙₛ (missing): D(3,5)=D(3,4)+w*ᵢₙₛ(missing). In the illustrated embodiment, this is the path to reach cell (3,5) that yields the smallest edit cost.

Referring again to FIG. 6, the immediately preceding example includes at act 638 a determination that the set of edit operations includes an insert operation for inserting a missing character marker at two character positions in the candidate string. Here, the set of edit operations corresponding to the minimum edit cost is determined to be: insert(missing), keep(B), keep(C), keep(D) and insert(missing). At act 642, included in the act of determining a candidate output string corresponding to the minimum edit cost 240, a set of edit operations includes the insert(missing) operation where the candidate output string is a partial string. That is, the partial string “?BCD?” includes the missing character label “?” both at an initial character position of the candidate string (in the space preceding the candidate character “B” at the first character position) and at a final position of the candidate string (the space following the candidate character “D” at the last character position). The minimum edit cost Dmin is high due to the special cost associated with two insert(missing) operations. The partial candidate output string “?BCD?” is returned to enable a determination of whether the candidate string 113F “BCD” is a match for the model string 116F “ABCDE” in the image 106F, see act 250 in FIG. 2. Here, the match is determined and a match status provided at the act 258. Because the partial candidate output string “?BCD?” has the lowest minimum edit cost it is selected as the output string at the act 275 and returned as the output string 118 at the act 280.

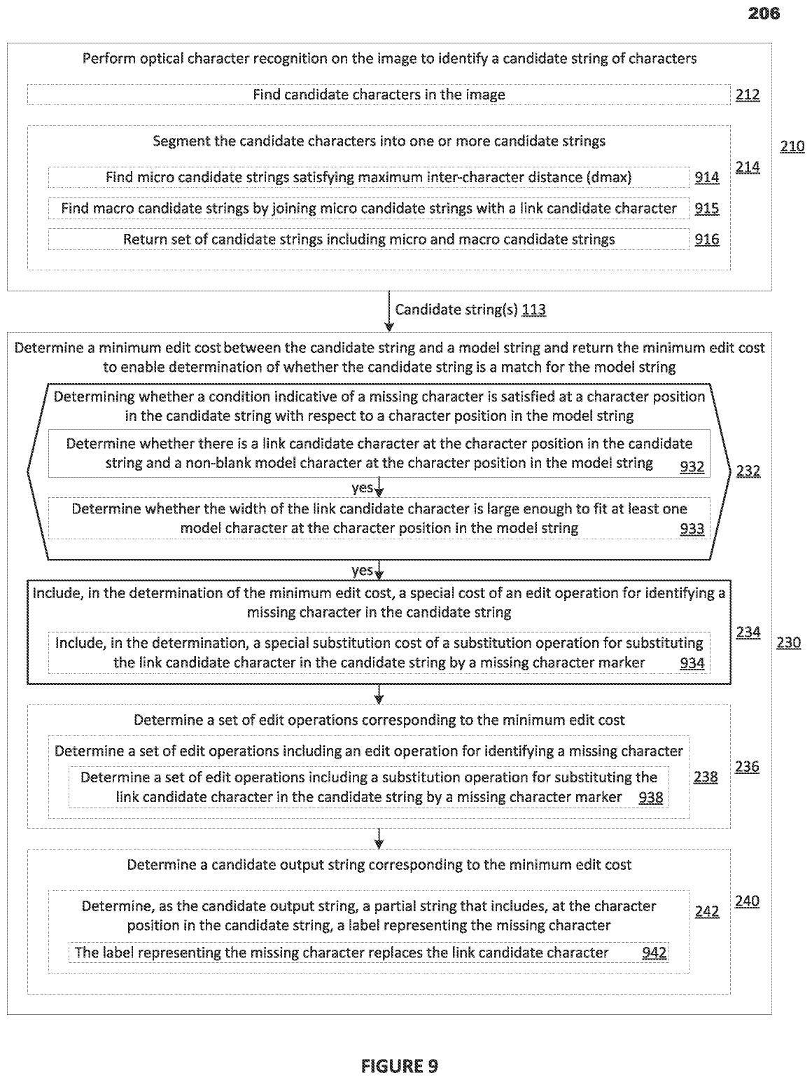

Embodiments described herein allow for processing of candidate strings that identifies a partial match between a candidate string and a model string. For example, various embodiments process candidate strings that are missing one or more characters at locations anywhere within the candidate string. Referring now to FIG. 9, a process 206 for calculating the minimum edit cost for a candidate string that is formed from a plurality of smaller candidate strings is illustrated in accordance with one embodiment. For purposes of the description herein, the smaller candidate strings are referred to as “micro” candidate strings. The candidate string formed from a plurality of micro candidate strings is referred to as a “macro” candidate string. According to the embodiments illustrated and described herein, each macro candidate string also includes a “link” candidate character that joins a first micro candidate string to a second micro candidate string to form the macro candidate string.

Referring to FIG. 9, a process flow diagram in accordance with an embodiment of the process illustrated in FIG. 2 where there is a link character, which links two shorter candidate strings, at a character position in the candidate string and a non-blank character at a corresponding character position in the model string. The process 206 provides further details of acts included in the act of performing optical character recognition on the image 210 and those included in the act of determining the minimum edit cost 230 in circumstances where a link character is employed to link two micro candidate strings to create a macro candidate string. According to these embodiments, the process 206 allows a minimum edit cost to be determined in the preceding circumstances.

According to the illustrated embodiment, at the act of performing optical character recognition on the image 210, the act 214 of segmenting the candidate characters into one or more character strings includes an act of finding micro candidate strings satisfying a maximum inter-character distance (dmax) 914, an act of finding macro candidate strings by joining micro candidate strings with a link candidate character 915, and an act of returning a set of candidate strings including both micro and macro candidate strings 916.

At the act of determining the minimum edit cost 230, the act of determining whether a condition indicative of a missing character is satisfied 232 includes an act of determining whether there is a link candidate character at the character position in the candidate string and a non-blank model character at the character position in the model string 932, and an act of determining whether the width of the link candidate character is large enough to fit at least one model character at the character position in the model string 933. Further, the act of including, in the determination of the minimum edit cost, a special cost of an edit operation for identifying a missing character in the candidate string 234 includes an act of determining a special substitution cost of a substitution operation for substituting the link candidate character in the candidate string by a missing character marker 934. Also, the act of determining a set of edit operations corresponding to the minimum edit cost 236 includes an act of determining a set of edit operations including a substitution operation for substituting the link candidate character in the candidate string by a missing character marker 938. The act of determining a candidate output string corresponding to the minimum edit cost 240 includes an act of determining, as the candidate output string, a partial string in which the link candidate character is replaced with the label representing the missing character 942. The act of determining the minimum edit cost 230 completed, the minimum edit cost (e.g., including the special substitution cost for substituting the link candidate character by a missing character marker) and the corresponding candidate output string (e.g., a partial string) are returned to enable determination of whether the candidate output string is a match for the model string, such as described previously with reference to FIGS. 1 and 2.

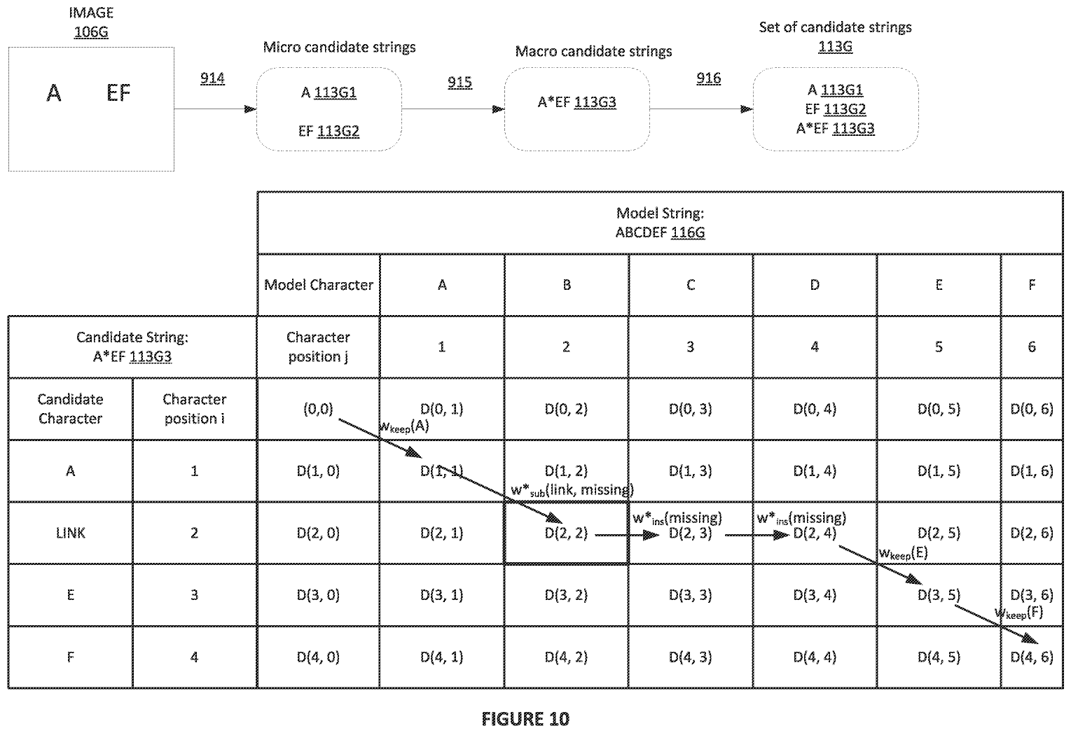

Referring now to FIG. 10, a DPA for calculating the minimum edit cost between a candidate string 113G3 “A*EF” (including a link candidate character at a second character position) and a model string 116G “ABCDE” is illustrated in accordance with one embodiment. The embodiment illustrated in FIG. 10 includes an image 106G including multiple micro candidate strings. A first micro candidate string 113G1 “A” and a second micro candidate string 113G2 “EF”. A macro candidate string 113G3 “A*EF” is formed by joining the micro candidate strings with a link candidate character. The resulting set of candidate strings 113G corresponding to the image 106G include the first micro candidate string 113G1, the second micro candidate string 113G2 and the macro candidate string 113G3. The operations illustrated in FIG. 10 are described here with reference to the process 206 illustrated and described with reference to FIG. 9.

To begin the calculation with the DPA, the minimum edit cost D(1,1) at cell (1,1) is determined using the cost wₖₑₑₚ of a keep operation of the candidate character “A” at the first character position (i=1) of the candidate string to match the model character “A” at the first character (j=1) of the model string. The minimum edit cost D(2,2) at cell (2,2), is calculated by determining whether a substitution operation of a link candidate character in the candidate string by a missing character marker is possible to move diagonally from D(1,1). For this, it is determined whether conditions of the act 932 and the act 933 are satisfied for cell (2,2). That is, at the act 932, it is determined that there is a link candidate character at the character position in the candidate string and a non-blank model character at the character position in the model string. At the act 933 it is determined that the width of the link candidate character is large enough to fit at least one model character at the character position in the model string. Here, since D(i,j) is defined and the conditions of acts 932 and 933 are satisfied, the minimum edit cost D(2,2) is calculated, at the act 934, as the minimum of the edit costs for each of the viable paths including the edit cost of proceeding diagonally from cell (1,1) by adding D(1,1) and the special substitution cost w*sub(link, missing). In this example, this path yielded the smallest edit cost and therefore D(2,2)=D(1,1)+w*sub(link, missing).

With the minimum edit cost determined for the substitution of a missing character marker for the link candidate character, the process illustrated in FIG. 6 are employed for an insert operation of a missing character marker. First, the minimum edit cost D(2,3) at cell (i=2, j=3), is calculated by determining whether it is possible to proceed horizontally from cell (2,2) to cell (2,3) by performing an insert operation of a missing character marker. For this, it is determined whether conditions of the act 632 and the act 633 of FIG. 6 are satisfied for cell (2, 3). At the act 632, it is determined that a non-blank model character “C” is located at the character position j=3 in the model string. At the act 633, it is determined that there is enough space between the previous candidate character “A” and the next candidate character “E” to insert the model character “C” at the character position j=3 in the model string following the substitution of the link character by a missing character marker at the character position i=2. According to this embodiment, the necessary width is assumed to be the width equal to the width of the model for the character “B”. Here, enough space exists between the previous candidate character “A” and the next candidate character “E” to insert the model character “C” at the character position j=3 in the model string. Because both conditions are satisfied, the minimum edit cost D(2,3) is calculated as the sum of the edit cost D(2,2) and the special insertion cost w*ᵢₙₛ (missing): D(2,3)=D(2,2)+w*ᵢₙₛ (missing).

The minimum edit cost D(2,4) at cell (i=2, j=4) is calculated by determining whether it is possible to proceed horizontally from cell (2,3) to cell (2,4) by performing an insert operation of a missing character marker. For this, it is determined whether conditions of the act 632 and the act 633 of FIG. 6 are satisfied for cell (2, 4). At the act 632, it is determined that a non-blank model character “D” located at the character position j=4 in the model string. At the act 633, it is determined that there is enough space between the previous candidate character “A” and the next candidate character “E” to insert the model character “D” at the character position j=4 in the model string following the substitution of the link character by a missing character marker at the character position i=2 and the insertion of a missing character at the character position j=3. That is, here a determination is made whether sufficient space is available for the model character “D” between the candidate characters “A” and “E” when that space is reduced by the widths of the characters “B” and “C” already added to the candidate string. According to this embodiment, the necessary width is assumed to be the width equal to the width of the model for the character “C”. Here, enough space exists to insert the model character “D” at the character position j=4 in the model string. Because both conditions are satisfied, the minimum edit cost D(2,4) is calculated as the sum of the edit cost D(2,3) and the special insertion cost w*ins(missing): D(2,4)=D(2,3)+w*ins(missing). The array is completed with two successive keep operations corresponding to character positions 5 and 6 of the string. The first of these keep operations proceeds from cell D(2,4) to D(3,5) where the candidate character “E” is kept. The second keep operation proceeds from cell D(3,5) to D(4,6) where the candidate character “F” is kept.

Referring again to FIG. 9, the immediately preceding example includes at act 938 a determination of the set of edit operations corresponding to the minimum edit cost results in the operations keep(A), substitute(link, missing), insert(missing), insert(missing), keep(E) and keep(F). At act 942, included in the act of determining a candidate output string corresponding to the minimum edit cost 240, a set of edit operations includes substitute(link, missing) and insert(missing) operations. The partial candidate output string “A???EF” is returned to enable a determination of whether the candidate string 113G3 “A*EF” is a match for the model string 116G “ABCDE” in the image 106G. The minimum edit cost Dmin is high due to the special cost associated with two insert(missing) operations. The partial candidate output string “A???EF” is returned to enable determination of whether the candidate string 113G3 “A*EF” is a match for the model string 116G “ABCDE” in the image 106G. Here, the match is determined and a match status provided at the act 258. Because the partial candidate output string “A???EF” has the lowest minimum edit cost it is selected as the output string at the act 275 and returned as the output string 118 at the act 280, see FIG. 2. In the example provided by FIG. 10, the candidate output string “A???EF” has a special cost which is high but also is the only candidate string with a finite value. For example, each of the two micro candidate strings 113G1 and 113G2 have a minimum edit cost that is an infinite value.

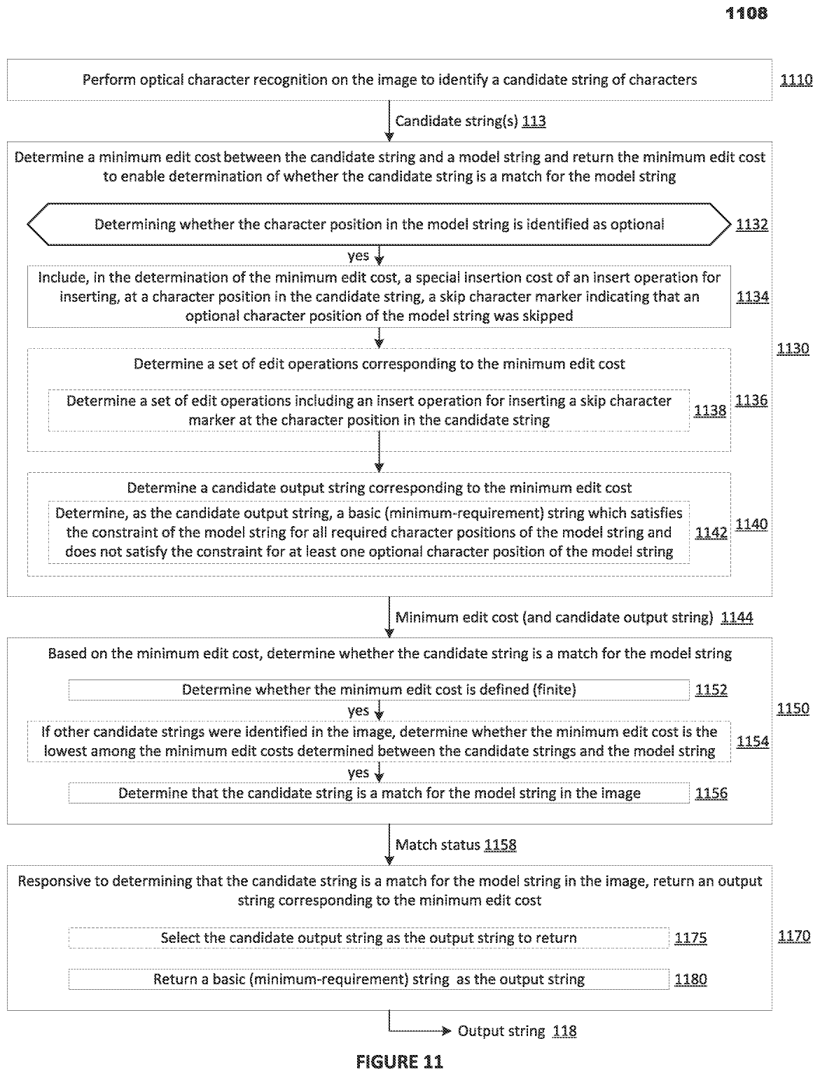

Referring now to FIG. 11, there is illustrated a flow diagram of an optical string recognition process 1108 for detecting candidate strings in an image using optical character recognition and processing the candidate strings to identify a match for a model string in the image where the model string includes one or more optional character positions in accordance with various embodiments. That is, the process 1108 illustrated in FIG. 11 addresses circumstances where a candidate string is missing a character at a character position identified as optional in the model string. For purposes of the description herein, a “basic” string (also referred to as a “minimum-requirement” string) refers to a candidate string that includes the required characters but is missing at least one of the optional characters.

The process 1108 includes four primary operations including an act of performing optical character recognition on an image 1110, an act of determining a minimum edit cost 1130, an act of determining whether a candidate string is a match for a model string 1150 and an act of returning an output string 1170. According to the illustrated embodiment, the act of performing optical character recognition on an image 1110 includes multiple acts (not illustrated) including an act of finding candidate characters in the image and an act of segmenting the candidate characters into one or more candidate strings.

According to the illustrated embodiment, the act of determining the minimum edit cost 1130 includes multiple acts including an act of determining whether the character position in the model string is identified as optional 1132; in the affirmative, an act of including, in the determination of the minimum edit cost, a special insertion cost of an insert operation for inserting, at a character position in the candidate string, a skip character marker indicating that an optional character position of the model string was skipped 1134; an act of determining a set of edit operations corresponding to the minimum edit cost 1136; and an act of determining a candidate output string corresponding to the minimum edit cost 1140. Further, the act 1136 includes an act of determining a set of edit operations including an insert operation for inserting a skip character marker at the character position in the candidate string 1138. The act 1140 includes an act of determining a basic (minimum-requirement) string, as the candidate output string, where the basic candidate output string satisfies the constraint of the model string for all required character positions of the model string and does not satisfy the constraint for at least one optional character position of the model string 1142.

Further, the act of determining whether a candidate string is a match for the model string 1150 includes multiple acts including an act of determining whether the minimum edit cost is defined 1152, an act of determining whether the minimum edit cost is the lowest among the minimum edit costs 1154 and an act of determining that the candidate string is a match for the model string in the image 1156. In addition, according to the illustrated embodiment, the act of returning the output string 1170 includes multiple acts including an act of selecting the candidate output string as the output string to return 1175 and an act of returning a basic (minimum-requirement) string as the output string 1180.

The overall operation of the process 1108 identifies a candidate string 113 at the act of performing optical character recognition on the image 1110 and moves to the act of determining a minimum edit cost 1130 to provide the minimum edit cost (and candidate output string) 1144. The minimum edit cost is employed at the act of determining whether the candidate string is a match for the model string 1150 and results in a match status 1158 (that is, match found or match not found). The process moves to the act of returning an output string 1170 where the match status is processed to provide an output string 118.

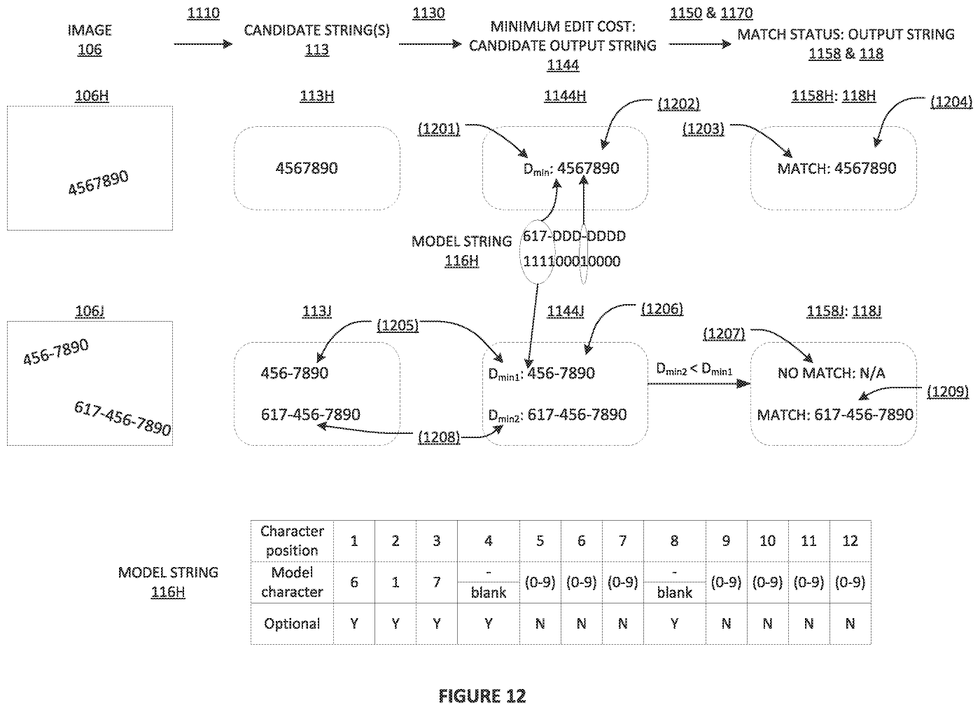

Operation of the process 1100 will be described with reference to FIG. 12, candidate strings identified in the images using optical character recognition and resulting output strings where the model string includes optional character positions. FIG. 12 illustrates two sets of examples where a model string 116H includes optional characters. Here, the model string 116H includes a maximum of 12 character positions where character positions 1-3 are numbers “6”, “1”, “7”. These character positions are optional. The fourth character position can include a hyphen or a blank space. This character position is also optional. Character positions 5-7 and 9-12 are numbers in the range from 0-9. According to the illustrated embodiment, the character positions 1-4 and 8 are optional while character positions 5-7 and 9-12 are required.

Each example in FIG. 12 includes an image 106, a resulting candidate string(s) 113, a candidate string having a minimum edit cost 1144, a match status 1158 and, where a match is found, an output string 118. The series of operations that are illustrated include the act of performing optical character recognition on the image 1110, the act of determining the minimum edit cost 1130, the act of determining whether the candidate string is a match for the model string 1150 and an act of returning an output string 1170.

The first example illustrated in FIG. 12 includes a first image 106H, a first set of candidate strings 113H, a first set of minimum edit costs 1144H, a first set of match statuses one for each of the first set of candidate output strings 1158H and a first output string 118H. The first image 106H includes a set of characters including seven numbers. These characters are not separated by any spaces or any hyphens. The resulting first candidate set of character strings 113H includes a single character string “4567890”. Referring to the process 1108, the optional character condition is satisfied at character positions 1-4 and 8 in the candidate string with respect to the character positions in the model string 116H at the act 1132. The first set of minimum edit costs 1144A includes a single minimum edit cost Dmin. Here, Dmin includes a special cost determined at the act 1134 where the special cost is attributable to an insert operation for inserting, at the optional character positions in the candidate string, a skip character marker indicating that an optional character position of the model string was skipped. The set of edit operations includes an insert operation for inserting a skip character marker at the optional character position in the candidate string. The first set of candidate output strings 1144H includes a single basic candidate output string “4567890” which meets the minimum requirements of the model string. That is, the output string 118H includes seven numbers and no other character positions.

According to the illustrated embodiment, the first set of minimum edit costs 1144A includes only a single defined minimum edit cost (Dmin). Further, because the first set of candidate string(s) only includes a single candidate string, the minimum edit cost is, by default, the lowest minimum edit cost among the set of identified candidate strings. The single candidate output string “4567890” is determined to be a match for the model string is returned as the output string at the act 1158H. The candidate string “4567890” is then returned as the output string 118H.

According to the illustrated embodiment, the second example illustrated in FIG. 12 differs from the first example because the image captured using optical character recognition includes two candidate character strings. The second example illustrated in FIG. 12 includes a second image 106J, a second set of candidate strings 113J, a second set of minimum edit costs 1144J, a second set of match statuses one for each of the second set of candidate output strings 1158J and a second output string 118J.

The second image 106J includes a first set of characters “456-7890” that form a first candidate string and a second set of characters “617-456-7890” that form a second candidate string. The first candidate string satisfies the optional character condition at character positions 1-4 with respect to the character positions in the model string 116H at the act 1132. Consequently, a resulting second set of candidate output strings 113J includes a first candidate output character string “456-7890” and a second candidate output character string “617-456-7890”. For the first candidate output character string, a special cost is included in the determination of a first minimum edit cost Dmin1 because the first candidate output string satisfies the optional character condition with optional character positions 1-4 skipped. The set of edit operations includes an insert operation for inserting a skip character marker at the first four character positions in the candidate string. In contrast, the second candidate output string includes a character at each of the 12 character positions. At act 1140, the second minimum edit cost Dmin2 does not include a special cost.

With first and second candidate output strings and an associated first and second minimum output costs, respectively, the process 1108 determines for each of the candidate output strings whether the minimum edit cost is the lowest among the plurality of minimum edit costs at the act 1170. As noted above, there is a significant special cost for any edit operation that results in an insert operation for inserting a skip character marker at one or more character position in the candidate string. Here, the result is that Dmin1 is substantially greater than Dmin2, and Dmin1 is not the lowest among the minimum edit costs of the candidate strings identified in the image. Instead, the second candidate output string including all optional characters results in the minimum edit cost (Dmin2). Because, the minimum edit cost Dmin2 is the lowest minimum edit cost among the identified candidate strings, the second candidate output string “617-456-7890” is determined to be a match for the model string at the act 1158 and is returned as the output string at the act 118J.

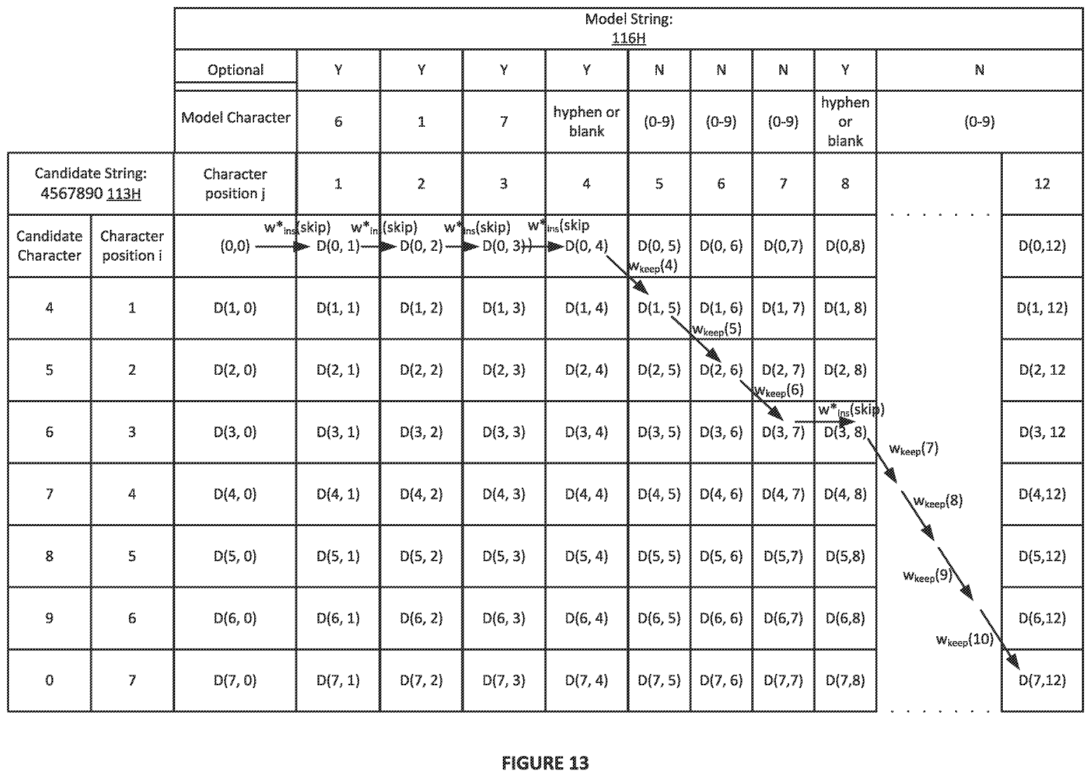

Referring now to FIG. 13, a DPA employed to calculate the minimum edit cost between a candidate string 113H “4567890” and a model string 116H “617(hyphen or blank)(0-9)(0-9)(0-9) (hyphen or blank)(0-9)(0-9)(0-9)(0-9)” is illustrated in accordance with one embodiment. For clarity, character positions 9-11 are not illustrated for the model character string. To begin the calculation with the DPA, the minimum cost D(0,1) is obtained at cell (0,1) by proceeding horizontally from cell (0,0) with the cost win s (skip) of an operation to skip the first character (j=1) of the model string. According to the illustrated embodiment, this operation is permissible because the first character position (j=1) of the model string is an optional character position. The minimum costs D(0,2), D(0,3) and D(0,4) are obtained similarly for each of cells (0,2), (0,3) and (0,4), respectively. Here too, each of character positions j=2, j=3, and j=4 of the model string is an optional character position. Thus, the cost wᵢₙₛ(skip) of the three operations to skip characters (j=2-4) of the model string is included in the minimum edit cost for the candidate string 113H.

The DPA array is navigated for character positions 5-7 of the model character string with three successive keep operations corresponding to character positions 5, 6 and 7 of the string. The first of these keep operations proceeds from cell D(0,4) to cell D(1,5) where the candidate character “4” is kept. The second keep operation proceeds from cell D(1,5) to cell D(2,6) where the candidate character “5” is kept. The third keep operation proceeds from cell D(2,6) to cell D(3,7) where the candidate character “6” is kept.

Another optional character position is present at character position j=8 of the model character string. Here, a horizontal path from cell D(3,7) to cell D(3,8) yields the smallest edit cost and therefore D(3,8)=D(3,7)+wᵢₙₛ (skip). The array is completed with four successive keep operations corresponding to character positions 9-12 of the model character string with the four successive keep operations corresponding to character positions 9, 10, 11 and 12 of the string. The first of these keep operations proceeds from cell D(3,8) to cell D(4,9) where the candidate character “7” is kept. The second keep operation proceeds from cell D(4,9) to cell D(5,10) where the candidate character “8” is kept. The third keep operation proceeds from cell D(5,10) to cell D(6,11) where the candidate character “9” is kept. The fourth keep operation proceeds from cell D(6,11) to cell D(7,12) where the candidate character “0” is kept.

According to this embodiment, the set of edit operations corresponding to the minimum edit cost (which can be obtained by backtracking through the DPA array) is determined to be: insert(skip, optional), insert(skip, optional), insert(skip, optional), insert(skip, optional), keep(4), keep(5), keep(6), insert(skip, optional), keep(7), keep(8), keep(9) and keep(0).

Here, the set of edit operations includes the multiple skip operations to skip optional character positions in the model string, the candidate output string includes seven characters rather than twelve characters. That is, the candidate string “4567890”. The minimum edit cost Dmin (which is high due to the special cost) for this candidate output string is returned for processing to determine whether the string “4567890” has the lowest minimum edit cost among all of the candidate character strings identified in the image (provided that more than one candidate character string is identified). According to various embodiments, an insertion, at a character position in the candidate string, a skip character marker indicating that an optional character position of the model string was skipped improves the OCR system relative to prior approaches because it allows a finite edit cost to be determined even in circumstances where an optional character is skipped.

While the embodiments described above with reference to FIGS. 5, 7, 8, 10 and 13, are described with respect to a dynamic programming array for implementing dynamic programming of the computation of a minimum edit cost between two strings, in other embodiments, the dynamic programming can be performed without the use of the dynamic programming array, without departing from the scope of the present invention.

FIG. 14 illustrates a block diagram for an exemplary data processing system 1400 that may be used in some embodiments. Data processing system 1400 includes one or more processors 1405 and connected system components (e.g., multiple connected chips). Alternatively, the data processing system 1400 is a system on a chip or Field-Programmable gate array. One or more such data processing systems 1400 may be utilized to implement the functionality of the optical string recognizer 108, related embodiments and related processes as illustrated and described with reference to FIGS. 1-13.

The data processing system 1400 is an electronic device which stores and transmits (internally and/or with other electronic devices over a network) code (which is composed of software instructions and which is sometimes referred to as computer program code or a computer program) and/or data using machine-readable media (also called computer-readable media), such as machine-readable storage media 1410 (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals), which is coupled to the processor(s) 1405. For example, the depicted machine readable storage media 1410 may store program code 1430 that, when executed by the processor(s) 1405, causes the data processing system 1400 to perform efficient and accurate barcode decoding. For example, the program code 1430 may include optical string recognizer code 108, which when executed by the processor(s) 1405, causes the data processing system 1400 to perform the operations described with reference to FIGS. 1-13.

According to these embodiments, an electronic device (e.g., a computer or an FPGA) includes hardware and software, such as a set of one or more processors coupled to one or more machine-readable storage media to store code for execution on the set of processors and/or to store data. For example, an electronic device may include non-volatile memory containing the code since the non-volatile memory can persist the code even when the electronic device is turned off. While the electronic device is turned on the part of the code that is to be executed by the processor(s) of the electronic device is copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

The data processing system 1400 may also include a display controller and display device 1420 to provide a visual user interface for the user, e.g., GUI elements or windows. The visual user interface may be used to enable a user to input parameters to the optical string recognizer 108 to decode barcodes, to view results of the string identification, or any other task.

The data processing system 1400 also includes one or more input or output (“I/O”) devices and interfaces 1425, which are provided to allow a user to provide input to, receive output from, and otherwise transfer data to and from the system. These I/O devices 1425 may include a mouse, keypad, keyboard, a touch panel or a multi-touch input panel, camera, frame grabber, optical scanner, an audio input/output subsystem (which may include a microphone and/or a speaker for, for example, playing back music or other audio, receiving voice instructions to be executed by the processor(s) 1405, playing audio notifications, etc.), other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 1400.

The I/O devices and interfaces 1425 may also include a connector for a dock or a connector for a USB interface, FireWire, Thunderbolt, Ethernet, etc., to connect the system 1400 with another device, external component, or a network. Exemplary I/O devices and interfaces 1425 also include wireless transceivers, such as an IEEE 802.11 transceiver, an infrared transceiver, a Bluetooth transceiver, a wireless cellular telephony transceiver (e.g., 2G, 3G, 4G), or another wireless protocol to connect the data processing system 1400 with another device, external component, or a network and receive stored instructions, data, tokens, etc. It will be appreciated that one or more buses may be used to interconnect the various components shown in FIG. 14.

It will be appreciated that additional components, not shown, may also be part of the system 1400, and, in certain embodiments, fewer components than that shown in FIG. 14 may also be used in a data processing system 1400. For example, in some embodiments the data processing system 1400 may include or be coupled with an image acquisition device for acquiring images.

Accordingly, the embodiments described above may be implemented in hardware, software, firmware, or any combination thereof. For example, they may be implemented in one or more computer programs executing on a programmable computer including a processor, a storage medium readable by the processor (including, for example, volatile and non-volatile memory and/or storage elements). According to some embodiments, the program code may be downloaded from a remote resource, for example, from a remote server accessed via the cloud over a wide area network such as the Internet.

Depending on the embodiment, the computer programs within the scope of the embodiments described herein may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Methods and associated acts in the various embodiments of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer, host systems or related accessories as well as other computers suitable for executing computer programs implementing the methods described herein.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of identifying a match for a model string in an image, the method comprising:
performing optical character recognition on the image to identify a candidate string, the candidate string including a plurality of candidate characters;
determining a minimum edit cost between the candidate string and the model string, the model string including a plurality of model characters, the minimum edit cost representative of a cost of edit operations performed on the candidate string to satisfy characteristics of the model string, wherein the determining the minimum edit cost includes:
responsive to determining that there is a missing or invalid candidate character at a character position in the candidate string with respect to a character position in the model string, determining the minimum edit cost using a special cost of an edit operation for identifying the missing or invalid candidate character in the candidate string;
determining, based on the minimum edit cost, whether the candidate string is a match for the model string; and
responsive to determining that the candidate string is a match for the model string, returning an output string corresponding to the minimum edit cost, wherein the returning the output string includes:
returning, as the output string, a partial string corresponding to the candidate string that includes a label representing the missing or invalid character at the character position in the candidate string.

2. The method of claim 1, wherein the candidate string is one of a set of one or more candidate strings identified in the image and wherein the determining, based on the minimum edit cost, whether the candidate string is a match for the model string includes determining whether the minimum edit cost is the lowest among the minimum edit costs determined between each of the set of candidate strings, respectively, and the model string.

3. The method of claim 2, wherein the special cost is set to a significantly higher value than edit costs of other types of edit operations used for determining the minimum edit cost, such that the partial string is returned as the output string only where none of the set of candidate strings identified in the image resulted in a full match.

4. The method of claim 1, further comprising responsive to determining that there is a blank candidate character at the character position in the candidate string and a non-blank model character at the character position in the model string, determining the minimum edit cost using a special substitution cost of a substitution operation for substituting the blank candidate character in the candidate string by a missing character marker.

5. The method of claim 1, further comprising responsive to determining that there is non-blank model character at the character position in the model string and that, at the character position in the candidate string, the distance between the last candidate character and the next candidate character is large enough to fit at least one model character at the character position in the model string, determining the minimum edit cost using a special insertion cost of an insert operation for inserting a missing character marker at the character position in the candidate string.

6. The method of claim 1, further comprising responsive to determining that there is non-blank model character at the character position in the model string and that the character position in the candidate string is an initial or final character position, determining the minimum edit cost using a special insertion cost of an insert operation for inserting a missing character marker at the character position in the candidate string.

7. The method of claim 1, further comprising responsive to determining that there is a link candidate character at the character position in the candidate string and a non-blank model character at the character position in the model string and further that the width of the link candidate character is large enough to fit at least one model character at the character position in the model string, determining the minimum edit cost using a special substitution cost of a substitution operation for substituting the link candidate character in the candidate string by a missing character marker.

8. A non-transitory computer-readable medium comprising computer program instructions executable by at least one computer processor that when executed by the at least one computer processor perform a method of identifying a match for a model string in an image, the method comprising:
performing optical character recognition on the image to identify a candidate string, the candidate string including a plurality of candidate characters;
determining a minimum edit cost between the candidate string and the model string, the model string including a plurality of model characters, the minimum edit cost representative of a cost of edit operations performed on the candidate string to satisfy characteristics of the model string, wherein the determining the minimum edit cost includes:
responsive to determining that there is a missing or invalid candidate character at a character position in the candidate string with respect to a character position in the model string, determining the minimum edit cost using a special cost of an edit operation for identifying the missing or invalid candidate character in the candidate string;
determining, based on the minimum edit cost, whether the candidate string is a match for the model string; and
responsive to determining that the candidate string is a match for the model string, returning an output string corresponding to the minimum edit cost, wherein the returning the output string includes:
returning, as the output string, a partial string corresponding to the candidate string that includes a label representing the missing or invalid character at the character position in the candidate string.

9. The non-transitory computer-readable medium of claim 8, wherein the candidate string is one of a set of one or more candidate strings identified in the image and wherein the determining, based on the minimum edit cost, whether the candidate string is a match for the model string includes determining whether the minimum edit cost is the lowest among the minimum edit costs determined between each of the set of candidate strings, respectively, and the model string.

10. The non-transitory computer-readable medium of claim 9, wherein the special cost is set to a significantly higher value than edit costs of other types of edit operations used for determining the minimum edit cost, such that the partial string is returned as the output string only where none of the set of candidate strings identified in the image resulted in a full match.

11. The non-transitory computer-readable medium of claim 8, the method further comprising responsive to determining that there is a blank candidate character at the character position in the candidate string and a non-blank model character at the character position in the model string, determining the minimum edit cost using a special substitution cost of a substitution operation for substituting the blank candidate character in the candidate string by a missing character marker.

12. The non-transitory computer-readable medium of claim 8, the method further comprising responsive to determining that there is non-blank model character at the character position in the model string and that, at the character position in the candidate string, the distance between the last candidate character and the next candidate character is large enough to fit at least one model character at the character position in the model string, determining the minimum edit cost using a special insertion cost of an insert operation for inserting a missing character marker at the character position in the candidate string.

13. The non-transitory computer-readable medium of claim 8, the method further comprising responsive to determining that there is non-blank model character at the character position in the model string and that the character position in the candidate string is an initial or final character position, determining the minimum edit cost using a special insertion cost of an insert operation for inserting a missing character marker at the character position in the candidate string.

14. The non-transitory computer-readable medium of claim 8, the method further comprising responsive to determining that there is a link candidate character at the character position in the candidate string and a non-blank model character at the character position in the model string and further that the width of the link candidate character is large enough to fit at least one model character at the character position in the model string, determining the minimum edit cost using a special substitution cost of a substitution operation for substituting the link candidate character in the candidate string by a missing character marker.

15. A method of identifying a match for a model string in an image, the method comprising:
performing optical character recognition on the image to identify a candidate string, the candidate string including a plurality of candidate characters;
determining a minimum edit cost between the candidate string and the model string, the model string including a plurality of model characters, the minimum edit cost representative of a cost of edit operations performed on the candidate string to satisfy characteristics of the model string, wherein the determining the minimum edit cost includes:
responsive to determining that a character position in the model string is identified as optional, determining the minimum edit cost using a special insertion cost of an insert operation for inserting, at a character position in the candidate string, a skip character marker indicating that an optional character position of the model string was skipped;
determining, based on the minimum edit cost, whether the candidate string is a match for the model string; and
responsive to determining that the candidate string is a match for the model string, returning an output string corresponding to the minimum edit cost, wherein the returning the output string includes:
returning, as the output string, a basic string corresponding to the candidate string.

16. The method of claim 15, wherein the candidate string is one of a set of one or more candidate strings identified in the image and wherein the determining, based on the minimum edit cost, whether the candidate string is a match for the model string includes determining whether the minimum edit cost is the lowest among the minimum edit costs determined between each of the set of candidate strings, respectively, and the model string.

17. The method of claim 16, wherein the special cost is set to a significantly higher value than edit costs of other types of edit operations used for determining the minimum edit cost, such that the basic string is returned as the output string only where none of the set of candidate strings identified in the image resulted in a full match.

18. The method of claim 15, wherein the optional character position is one of a plurality of optional character positions, and wherein the method further comprises determining the special edit costs including a special insertion cost for each insert operation by which a skip character marker is inserted at a location of one of the plurality of optional character positions in the candidate string, respectively.

19. A non-transitory computer-readable medium comprising computer program instructions executable by at least one computer processor that when executed by the at least one computer processor perform a method of identifying a match for a model string in an image, the method comprising:
performing optical character recognition on the image to identify a candidate string, the candidate string including a plurality of candidate characters;
determining a minimum edit cost between the candidate string and the model string, the model string including a plurality of model characters, the minimum edit cost representative of a cost of edit operations performed on the candidate string to satisfy characteristics of the model string, wherein the determining the minimum edit cost includes:
responsive to determining that a character position in the model string is identified as optional, determining the minimum edit cost using a special insertion cost of an insert operation for inserting, at a character position in the candidate string, a skip character marker indicating that an optional character position of the model string was skipped;
determining, based on the minimum edit cost, whether the candidate string is a match for the model string; and
responsive to determining that the candidate string is a match for the model string, returning an output string corresponding to the minimum edit cost, wherein the returning the output string includes:
returning, as the output string, a basic string corresponding to the candidate string.

20. The non-transitory computer-readable medium of claim 19, wherein the candidate string is one of a set of one or more candidate strings identified in the image and wherein the determining, based on the minimum edit cost, whether the candidate string is a match for the model string includes determining whether the minimum edit cost is the lowest among the minimum edit costs determined between each of the set of candidate strings, respectively, and the model string.

21. The non-transitory computer-readable medium of claim 20, wherein the special cost is set to a significantly higher value than edit costs of other types of edit operations used for determining the minimum edit cost, such that the basic string is returned as the output string only where none of the set of candidate strings identified in the image resulted in a full match.

22. The non-transitory computer-readable medium of claim 19, wherein the optional character position is one of a plurality of optional character positions, and wherein the method further comprises determining the special edit costs including a special insertion cost for each insert operation by which a skip character marker is inserted at a location of one of the plurality of optional character positions in the candidate string, respectively.
